(19) United States
(12) Patent Application Publication
(10) Pub. No.: US 2012/0225246 A1
(43) Pub. Date: Sep. 6, 2012

(54) PRINT-RECEPTIVE MEDIA AND RELATED METHODS

(76) Inventors: Haochuan Wang, South Pasadena, CA (US); Thomas Mammen, La Verne, CA (US); Arthur G. Castillo, Chino Hills, CA (US); Frank Yen-Jer Shih, Arcadia, CA (US); Anahit Tataryan, Arcadia, CA (US)

(21) Appl. No.: 13/037,750

(22) Filed: Mar. 1, 2011

(51) Int. Cl. B32B 3/00; B05D 5/04

(52) U.S. Cl. 428/141; 427/256

(57) ABSTRACT

The present invention includes a print-receptive medium including a print-receptive surface. The print-receptive surface having a plurality of peaks and a plurality of valleys. The print-receptive surface also has a primary profile that includes a mean surface. Each of the plurality of peaks has a height measured from the mean surface, and each of the valleys has a depth measured from the mean surface. The plurality of peaks has a mean peak height, Ppm, and the plurality of valleys has a mean valley depth, Pvm. The primary profile of the print-receptive surface has a value of Ppm-Pvm greater than about 0.23 micron.

### BACKGROUND

The present invention relates generally to electrophotographic printing and relates more particularly to print-receptive media for use in electrophotographic printing.

The three principal types of printing devices used for printing text, graphics, or images that are used in the home, at school, or in the workplace are electrophotographic printers, inkjet printers, and hot-melt printers. Of these various types of printers, electrophotographic printers, which include, for example, laser printers, LED printers, and copying machines, dominate the market share for office printing/copying, and are also becoming more affordable and attractive to home and school users.

The electrophotographic process is typically as follows: First, a negative electrostatic charge is uniformly distributed over the surface of a rotatable cylinder 2, often referred to as “the drum,” the drum rotating at the speed of paper output. See FIG. 1. The aforementioned electrostatic charge can be applied to the drum by contacting the drum with a charged contact roller 4. Next, the matter to be printed is imaged onto the surface of the rotating drum usually with a laser 6. Where there is an image on the drum, the charge is dissipated, and where there is no image on the drum, the charge on the drum remains. Next, the rotating drum is brought into contact with a developer roller 8 carrying a negatively charged toner mixture. The developer roller brushes the toner mixture onto the drum, with the toner mixture coating the uncharged areas of the drum through electrostatic attraction. Next, a sheet of print-receptive medium 10, for example, a sheet of paper, coated paper, film, coated film, laminates of paper and film, address labels, file folder labels, stickers, and other labels, business cards, greeting cards, name badges, or tent cards, etc., is typically passed between the drum and a transfer roller 12, the transfer roller applying a charge to the print-receptive medium that is opposite to that of the toner mixture, whereby the toner image is transferred, through pressure and electrostatic attraction, from the drum to the print-receptive medium. After contacting the print-receptive medium, the drum is typically cleaned of any remaining toner using a rotating brush under suction or a cleaner blade 14. The toner image previously transferred from the drum to the print-receptive medium is then permanently fixed to the print-receptive medium using a heat and pressure mechanism or a radiant fusing technology to melt and to bond the toner particles to the print-receptive medium. The electrophotographic process is also described in U.S. Pat. No. 5,185,496 to Nishimura, et al., which is incorporated herein in its entirety.

One of the problems associated with electrophotographic printing is that toner particles tend to accumulate along the entire path taken by the print-receptive medium 10. In particular, small toner particles can remain on the drum 2 after passing the brush or cleaner blade 14. As a result, some of the accumulated toner particles can transfer to, and eventually become fused with, the print-receptive medium. The net result of this phenomenon is that unprinted areas, where unprinted areas are those areas not intended to be printed upon in a given pass through the printer, acquire a grayish or otherwise discolored appearance. This effect is not too noticeable in those instances in which the print-receptive medium passes through the printer only one time. However, in instances in which the print-receptive medium passes through the printer a plurality of times, the graying or discoloration effect, which can be cumulative, can be quite noticeable. As used herein, the term plurality means two or more. Multiple passing, also known as re-feeding, of the print-receptive medium can take place, for example, when the print-receptive medium includes a matrix of cards or labels arranged on a common sheet and one wishes to print onto only some of the cards or labels at one time, saving the remainder of the cards or labels for printing in one or more subsequent passes through the printer. Consequently, where, for example, a matrix of labels is arranged on a common sheet, and a user prints onto only one label with each pass through the printer, the discoloration on the unprinted, remaining labels can be quite pronounced after several such passes through the printer.

It should, therefore, be appreciated that there is a need for print-receptive media that can be passed through an electrophotographic printer a plurality of times resulting in reduced graying or discoloration of the unprinted areas of the print-receptive media. The present invention satisfies this need.

### SUMMARY

The present invention includes a print-receptive medium including a print-receptive surface. The print-receptive surface having a plurality of peaks and a plurality of valleys. The print-receptive surface also has a primary profile that includes a mean surface. Each of the plurality of peaks has a height measured from the mean surface, and each of the valleys has a depth measured from the mean surface. The plurality of peaks has a mean peak height, Ppm, and the plurality of valleys has a mean valley depth, Pvm. The primary profile of the print-receptive surface has a value of Ppm-Pvm greater than about 0.23 micron.

In other, more detailed features of the invention, the primary profile of the print-receptive surface has a value of Ppm-Pvm greater than or equal to about 0.51 micron. In other, more detailed features of the invention, the primary profile of the print-receptive surface has a value of Ppm-Pvm ranging from about 0.51 micron to about 6.35 microns.

In other, more detailed features of the invention, the print-receptive medium includes a print-receptive surface having a primary bearing ratio at threshold 5 microns. The primary bearing ratio at threshold 5 microns of the print-receptive surface has a value less than about 7.11%.

In other, more detailed features of the invention, the primary bearing ratio at threshold 5 microns of the print-receptive surface has a value less than or equal to about 1.51%. In other, more detailed features of the invention, the primary bearing ratio at threshold 5 microns of the print-receptive surface has a value less than or equal to about 1.51% and a value of Ppm-Pvm greater than or equal to about 0.96 micron. In other, more detailed features of the invention, the primary bearing ratio at threshold 5 microns of the print-receptive surface has a value ranging from about 0.66% to about 1.51% and a value of Ppm-Pvm ranging from about 0.96 micron to about 4.76 microns.

In other, more detailed features of the invention, the print-receptive medium includes a print-receptive surface having a ΔE*_{ab} value. The value of ΔE*_{ab} is less than about 1.68 after ten passes through an electrophotographic printer.

In other, more detailed features of the invention, the value of ΔE*_{ab} is less than or equal to about 1.32 after ten passes through an electrophotographic printer. In other, more detailed features of the invention, the value of ΔE*_{ab} ranges from about 0.64 to about 1.32 after ten passes through an electrophotographic printer.

In other, more detailed features of the invention, the print-receptive medium includes a coating. The print-receptive surface is formed on the coating. The coating includes about 100 parts by weight of polyvinyl acetate, up to about 55 parts by weight of polyamide, up to about 105 parts by weight of silica, about 8.75 parts by weight sodium chloride, and up to about 7.25 parts by weight of a thickener. In other, more detailed features of the invention, the coating includes about 13.12 parts by weight to about 105 parts by weight of silica.

In other, more detailed features of the invention, the print-receptive surface has a primary high spot count, PHSC, value, and the PHSC value is less than about 2.71 peaks/mm. In other, more detailed features of the invention, the PHSC value is less than or equal to about 1.63 peaks/mm and the value of Ppm-Pvm is greater than or equal to about 0.51 micron. In other, more detailed features of the invention, the PHSC ranging from about 0.34 peaks/mm to about 1.63 peaks/mm and the value of Ppm-Pvm ranges from about 0.51 micron to about 6.35 microns.

The present invention also includes a method for forming a print-receptive medium including a print-receptive surface. The method includes providing a substrate having a coating surface, providing a coating mixture, coating the mixture onto the coating surface, and drying the coating mixture. The dried coating mixture forms the print-receptive surface having a plurality of peaks and a plurality of valleys. The print-receptive surface has a primary profile that includes a mean surface. Each of the plurality of peaks has a height measured from the mean surface, and each of the valleys has a depth measured from the mean surface. The plurality of peaks has a mean peak height, Ppm, and the plurality of valleys has a mean valley depth, Pvm. The primary profile of the print-receptive surface has a value of Ppm-Pvm greater than about 0.23 micron.

Other features of the invention should become apparent to those skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. It should be noted that the drawings are not drawn to scale. In the drawings wherein like reference numerals represent like parts:

FIG. 1 is a schematic view of an electrophotographic printer mechanism;

FIGS. 2(a) and 2(b) are top and side views, respectively, of a first embodiment of a print-receptive medium constructed according to the present invention;

FIGS. 3(a) and 3(b) are top and side views, respectively, of a second embodiment of a print-receptive medium constructed according to the present invention;

FIG. 4 is a side view of a third embodiment of a print-receptive medium constructed according to the present invention;

FIG. 5 is a side view of a fourth embodiment of a print-receptive medium constructed according to the present invention;

FIG. 6 is a graph of a primary profile of the print-receptive surface of an embodiment of the present invention;

FIG. 7 is a graph of Abbott-Firestone curve of the print-receptive surface of an embodiment of the present invention;

FIG. 8 is an illustration showing the relationship between a raw surface profile, a primary profile, a roughness profile, and a smoothness profile of a surface;

FIG. 9 is graph showing the relationship between a mean surface and a surface profile having a sine wave profile;

FIG. 10 is a graph showing the relationship between a mean surface and a surface profile having a sine wave profile where the valleys of the sine wave have been stretched;

FIG. 11 is a graph showing the relationship between the mean surface and a surface profile having a sine wave profile where the peaks of the sine wave have been stretched;

FIG. 12 is a graph of a primary profile of the print-receptive surface of an embodiment of the present invention showing a bearing ratio at threshold z;

FIG. 13 is a schematic view of a sheet of print-receptive medium of the present invention in contact with a printer drum;

FIG. 14 is a plot of Pa values against the primary bearing ratio at 5 microns values for Textured Samples, Laser Samples, Inkjet Samples, and Exemplary Samples;

FIG. 15 is a plot of the average Pa values against the average primary bearing ratio at 5 microns values for Textured Samples, Laser Samples, Inkjet Samples, and Exemplary Samples;

FIG. 16 is a plot of the Pa values against the primary bearing ratio at 10 microns values for Textured Samples, Laser Samples, Inkjet Samples, and Exemplary Samples;

FIG. 17 is a plot of the average Pa values against the average primary bearing ratio at 10 microns values for Textured Samples, Laser Samples, Inkjet Samples, and Exemplary Samples;

FIG. 18 is a plot of the Ppm-Pvm values against the primary bearing ratio at 5 microns values for Textured Samples, Laser Samples, Inkjet Samples, and Exemplary Samples;

FIG. 19 is a plot of the average Ppm-Pvm values against the average primary bearing ratio at 5 microns values for Textured Samples, Laser Samples, Inkjet Samples, and Exemplary Samples;

FIG. 20 is a plot of the Ppm-Pvm values against the primary bearing ratio at 10 microns values for Textured Samples, Laser Samples, Inkjet Samples, and Exemplary Samples;

FIG. 21 is a plot of the average Ppm-Pvm values against the average primary bearing ratio at 10 microns values for Textured Samples, Laser Samples, Inkjet Samples, and Exemplary Samples;

FIG. 22 is a plot of the average Ppm-Pvm values against the average Pa values for Textured Samples, Laser Samples, Inkjet Samples, and Exemplary Samples;

FIG. 23 is a plot of the primary high spot count values against the Ppm-Pvm values for Textured Samples, Laser Samples, Inkjet Samples, and Exemplary Samples;

FIG. 24 is a flowchart of a method according to the present invention for forming a print-receptive medium embodiment;

FIG. 25 is a flowchart of an alternative method according to the present invention for forming a print-receptive medium embodiment;

FIG. 26 is a plot of the ΔE*_{ab} values against the average primary bearing ratio at 5 microns values for Textured Samples, Laser Samples, Inkjet Samples, and Exemplary Samples;

FIG. 27 is a plot of the ΔE*_{ab} values against the average primary bearing ratio at 10 microns values for Textured Samples, Laser Samples, Inkjet Samples, and Exemplary Samples;

FIG. 28 is a plot of the ΔE*_{ab} values against the average Ppm-Pvm values for Textured Samples, Laser Samples, Inkjet Samples, and Exemplary Samples; and

FIG. 29 is a plot of the ΔE*_{ab} values against the average Pa values for Textured Samples, Laser Samples, Inkjet Samples, and Exemplary Samples.

### DETAILED DESCRIPTION OF PREFERRED EMBODIMENTS

The present invention is embodied in print-receptive media, and related methods, that include a print-receptive surface. Print-receptive media come in a multitude of configurations. A few non-limiting examples of print-receptive media are discussed below.

The present invention is based, at least in part, on the surprising discovery that the undesired graying or other discoloration of print-receptive media in unprinted areas following passage of the print-receptive media through an electrophotographic printer, particularly following multiple passages of the print-receptive media through the electrophotographic printer, can be reduced by reducing the surface area of the print-receptive media exposed to the drum 2, based on the surface profile of the print-receiving surface of the print-receptive medium.

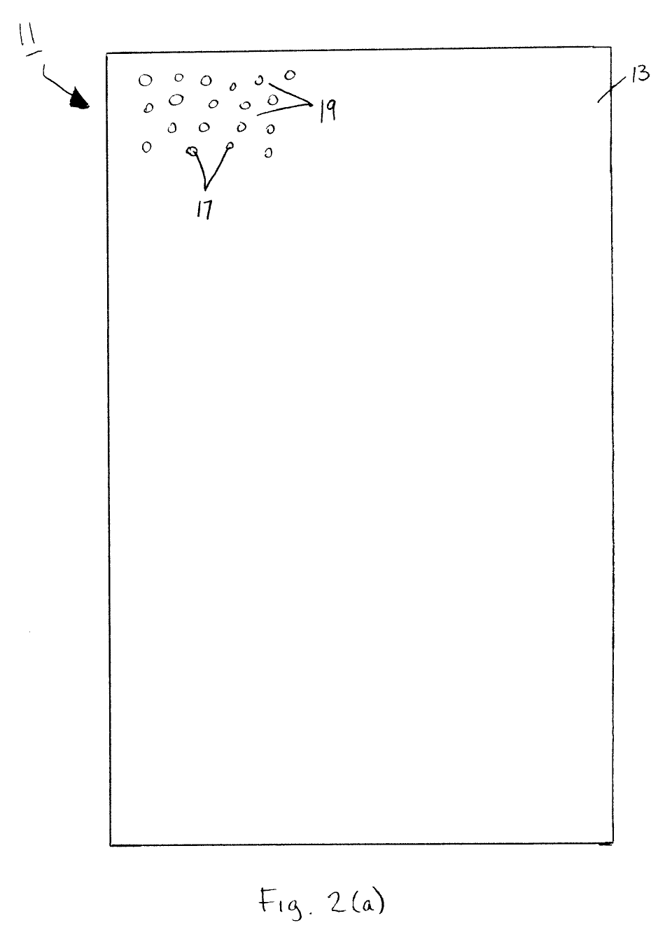

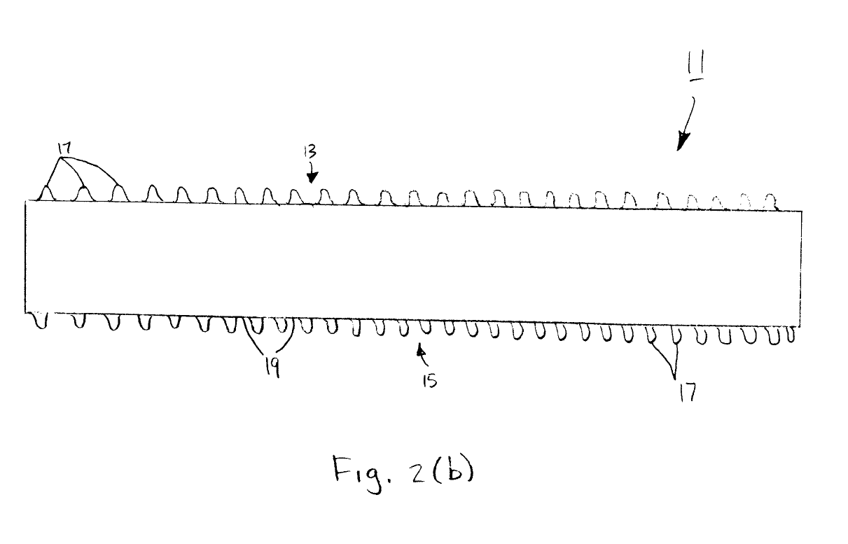

Print-receptive media can take various physical forms. For example, referring now to FIGS. 2(a) and 2(b), there are shown top and side views, respectively, of a first embodiment of a print-receptive medium constructed according to the teachings of the present invention, the print-receptive medium being represented generally by reference numeral 9. (For simplicity and clarity, only some of the print-receptive surface of print-receptive medium 11 is shown in FIGS. 2(a) and 2(b).)

Print-receptive medium 11 can include a unitary sheet of material, which can be, for example, a paper or an opaque, clear, or translucent polymeric film. Print-receptive medium 11 can have a top surface 13 and a bottom surface 15. Top surface 13 and bottom surface 15 can be provided with a plurality of peaks 17 and valleys 19, which can be made, for example, by embossing or calendaring. The peaks 17 and valleys 19 endowing top surface 13 and bottom surface 15 with the desired print-receptive surface described below.

In use, print-receptive medium 11 can be fed into an electrophotographic printer, with either top surface 13 or bottom surface 15 being used as the print-receiving surface.

As can be appreciated, although both top surface 13 and bottom surface 15 of print-receptive medium 11 are constructed to provide the desired surface roughness, one could modify print-receptive medium 11 so that only one of top surface 13 and bottom surface 15 possesses such surface roughness.

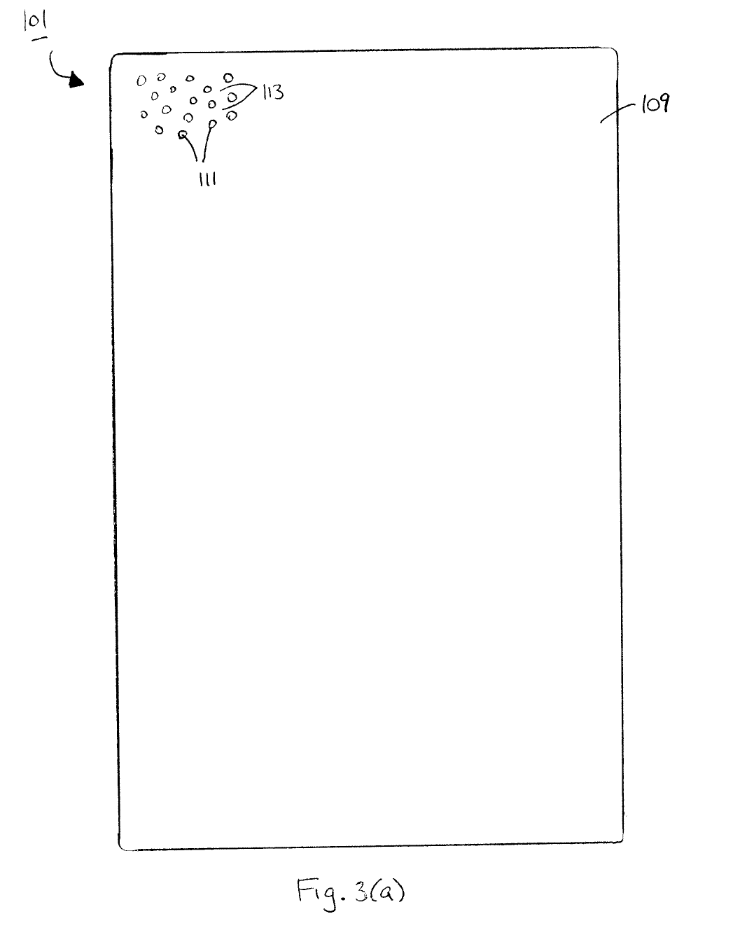

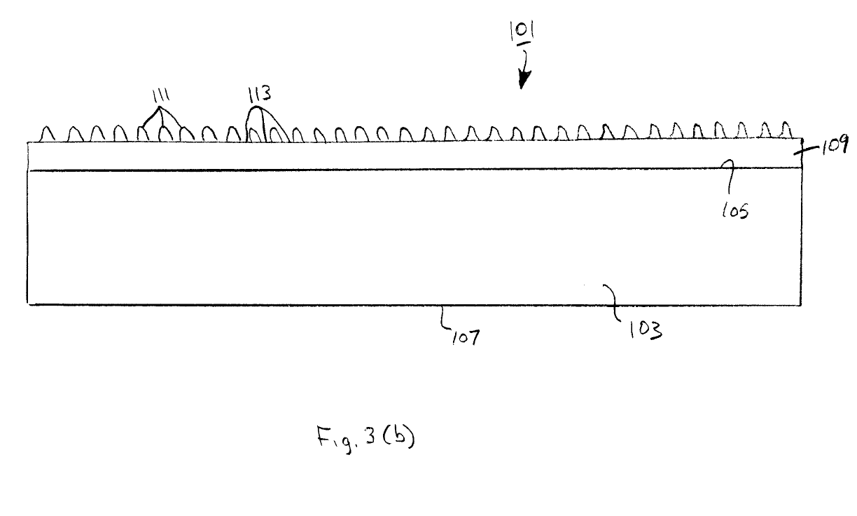

Referring now to FIGS. 3(a) and 3(b), there are shown top and side views, respectively, of a second embodiment of a print-receptive medium constructed according to the teachings of the present invention, said print-receptive medium being represented generally by reference numeral 101. (For simplicity and clarity, only some of the print-receptive surface of print-receptive medium 101 is shown in FIGS. 3(a) and 3(b).)

Print-receptive medium 101 can include a substrate 103, which can be, for example, a paper or an opaque, clear, or translucent polymeric film. Substrate 103 can have a top surface 105 and a bottom surface 107. Print-receptive medium 101 can further include a coating 109 applied to top surface 105 of substrate 103. Coating 109, which can have a composition as described below and which can be formed as described below, is shaped to include a plurality of peaks 111 and valleys 113 to endow print-receptive medium 101 with the above-described desired surface roughness.

In use, print-receptive medium 101 can be fed into an electrophotographic printer, with coating 109 preferably being used as the print-receiving surface.

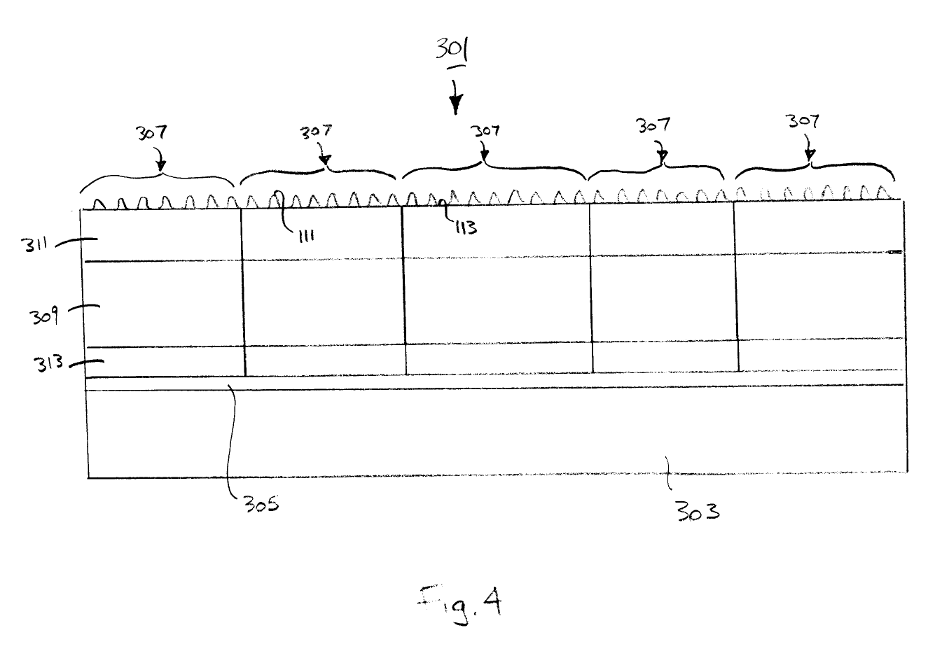

Referring now to FIG. 4, there is shown a side view of a third embodiment of a print-receptive medium constructed according to the teachings of the present invention, the print-receptive medium being represented generally by reference numeral 301. (For simplicity and clarity, only some of the print-receptive surface of print-receptive medium 301 is shown in FIG. 4).

Print-receptive medium 301 can include a carrier 303 which can be, for example, a paper backing, a polymeric film, or another suitable material. A release coating 305 can be applied to the top surface of carrier 303. Print-receptive medium 301 can further include a plurality of print-receiving members 307 removably positioned on top of release coating 305, the number, size, and shape of print-receiving members 307 shown being merely illustrative. Each member 307 can be a pressure-sensitive adhesive label that can include a substrate 309, a print-receiving coating 311, and a pressure-sensitive adhesive 313, coating 311 being applied to the top surface of substrate 309 and adhesive 313 being applied to the bottom surface of substrate 309. Substrate 309 can be identical to substrate 103 of print-receptive medium 101, and coating 311 can be identical to coating 109 of print-receptive medium 101. Alternatively, in another embodiment (not shown), substrate 309 and coating 311 can be replaced with a structure identical to print-receptive medium 11. As in the present embodiment, adjacent members 307 can be coupled to one another only through carrier 303; however, print-receptive medium 301 can be modified so as to directly couple together adjacent members 307, for example, through perforations or otherwise.

In use, print-receptive medium 301 can be fed into an electrophotographic printer, with coatings 311 preferably being used as the print-receiving surfaces. If desired, print-receptive medium 301 can be passed through an electrophotographic printer, with printing applied to only some of members 307. Such printed-upon members 307 can then be detached from the remainder of print-receptive medium 301, and the remainder of print-receptive medium 301 can then be passed one or more times through the printer for printing onto some of the remaining members 307.

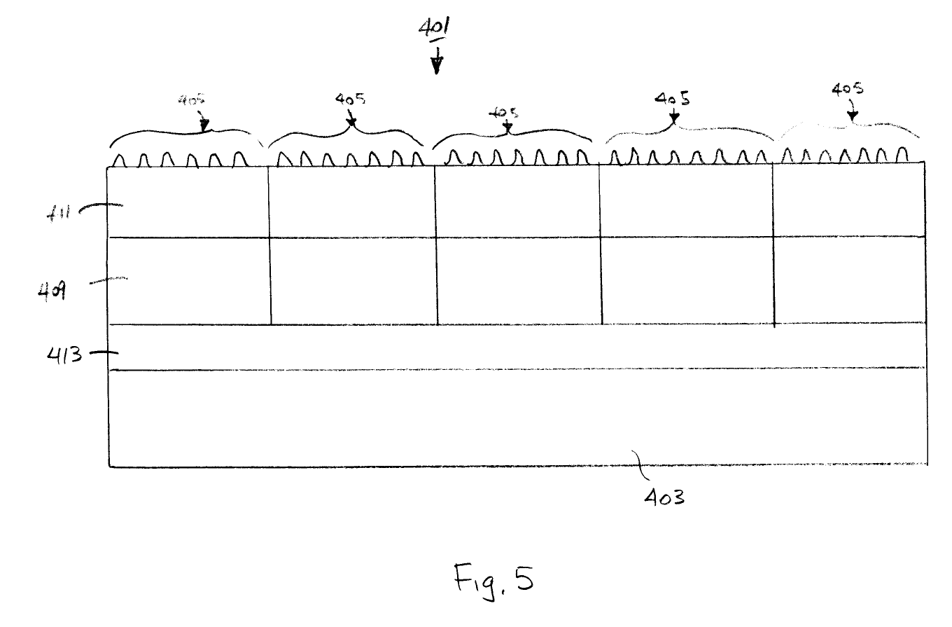

Referring now to FIG. 5, there is shown a side view of a fourth embodiment of a print-receptive medium constructed according to the teachings of the present invention, said print-receptive medium being represented generally by reference numeral 401. (For simplicity and clarity, only some of the print-receptive surface of print-receptive medium 401 is shown in FIG. 5.)

Print-receptive medium 401 can include a carrier 403 which can be, for example, a paper backing, a polymeric film, or another suitable material. Print-receptive medium 401 can further include a plurality of print-receiving members 405, the number, size, and shape of print-receiving members 405 shown being merely illustrative. Each member 405 can be a card and can include a substrate 409 and a print-receiving coating 411, coating 411 being applied to the top surface of substrate 409. Substrate 409 can be identical to substrate 103 of print-receptive medium 101, and coating 411 can be identical to coating 109 of print-receptive medium 101. (Alternatively, in another embodiment (not shown), substrate 409 and coating 411 can be replaced with a structure identical to print-receptive medium 11.) Print-receptive medium 401 can further include a layer of adhesive 413 removably adhering members 405 to carrier 403. Adhesive 413 can be a dry-tack adhesive, i.e., not tacky at room temperature, or a removable or ultraremovable adhesive. In this manner, after a member 405 has been removed from carrier 403, the adhesive will remain with carrier 403, will remain on member 405, or can split, with a portion on carrier 403 and a portion on member 405. Alternatively, the carrier can be a breakable film directly attached, without adhesive 413, to the carrier such that the members can be broken apart.

In use, print-receptive medium 401 can be fed into an electrophotographic printer, with coatings 411 preferably being used as the print-receiving surfaces. If desired, print-receptive medium 401 can be passed through an electrophotographic printer, with printing applied to only some of members 405. Such printed-upon members 405 can then be detached from the remainder of print-receptive medium 401, and the remainder of print-receptive medium 401 can then be passed one or more times through the printer for printing onto some of the remaining members 405.

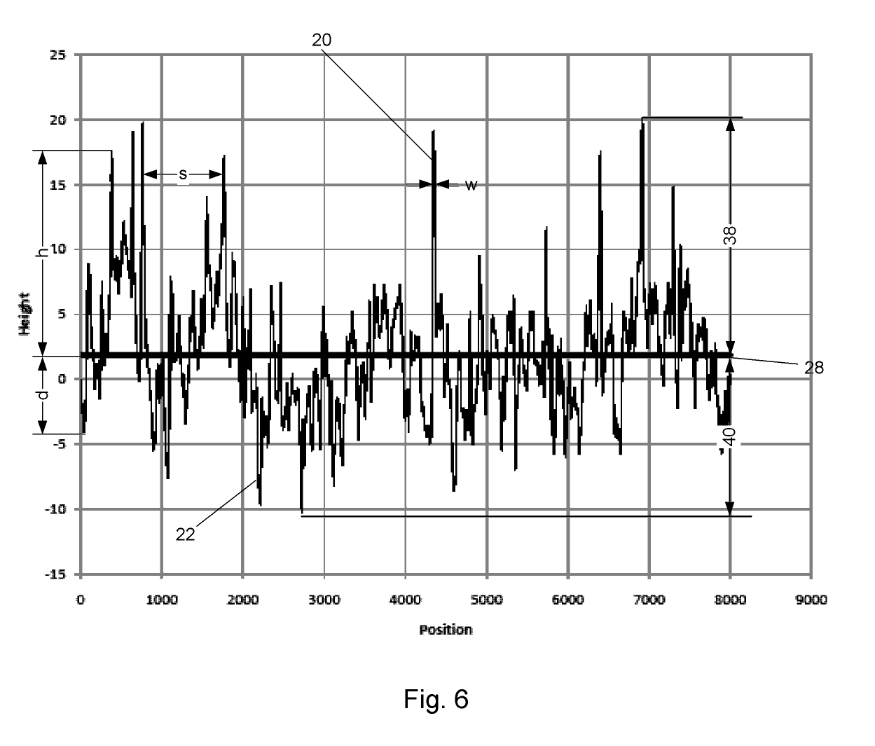

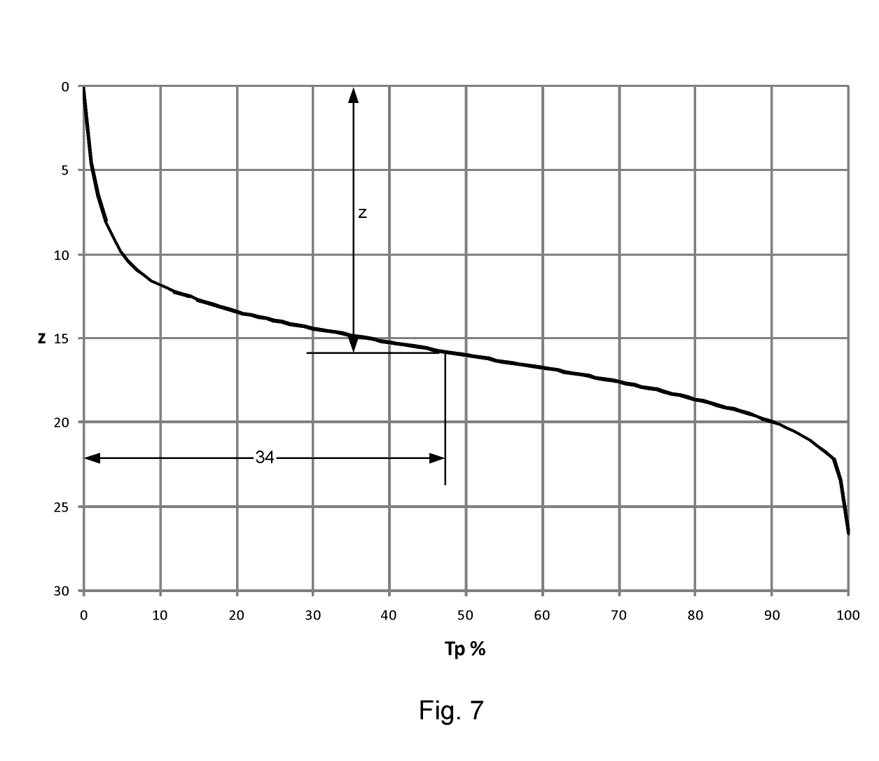

Turning now to the print-receptive surface of the print-receptive media, FIG. 6 is a graph of a primary profile (described below) of the print-receptive surface of an embodiment of the present invention. In particular, the print-receptive surface can characterized as including peaks 20, also known as protrusions, and valleys 22. Furthermore, each peak and valley can be further characterized by its height h or depth d as measured from the mean surface 28 (described below), width w, shape, and spacing s. Additional information about the print-receptive surface can be obtained by examining the Abbott-Firestone curve, or bearing ratio curve, (see FIG. 7) which relates the amount of material (Tp % (ASME B46.1-2002), also known as the bearing length ratio) 34 as a function of depth z as measured from the highest peak. One method of characterizing the print-receptive surface profile is by using a surface profilometer. One type of profilometer (DEKTAK 8 profilometer, Veeco Instruments, Inc., Plainview, N.Y., USA) uses a stylus to measure the peaks and valleys. An overview of how a stylus profilometer operates and the values characterizing the peaks and valleys is found in Explanation of Surface Characteristics—Standards (found at http://www.accretech.jp/english/pdf/measuring/sfexplain_e.pdf, Tokyo Seimitsu Co., Tokyo, Japan), attached as Appendix A and incorporated herein in its entirety, and Basic Components and Elements of Surface Topography found at http://www.bcmac.com/pdf_files/surface%20finish%20101.pdf (B.C. MacDonald and Company, St. Louis, Mo., USA), attached as Appendix B and incorporated herein in its entirety. Parameters of particular interest include Pp 38 (see FIG. 6), Pv 40, Pa, Ppm, and Pvm. Additionally, referring back to FIG. 7, the material ratio 34 (Tp %), also known as the bearing ratio, at a specified depth z below the highest peak, i.e., the relative amount of material that a plane parallel to the mean surface cuts through at depth z below the highest peak, can be calculated from the Abbott-Firestone curve. Accordingly, the bearing ratio at threshold 5 microns (BR(5)), as used herein, is defined as the value of Tp % when z=5 microns, and the bearing ratio at threshold 10 microns (BR(10)), as used herein, is defined as the value of Tp % when z=10 microns. All of these parameters can be obtained from surface analysis software, for example, TRUESURF (TrueGage, North Huntingdon, Pa., USA).

Spacing of the peaks can be determined by counting the number of peaks that extend above a specified depth as measured from the highest peak. One method of counting the number of peaks is by using the high spot count (HSC). The high spot count is defined as the number of peaks that project through a plane parallel to the mean surface at a selected distance from the mean surface. As used herein, PHSC is the number of peaks that project through a plane parallel to the mean surface of the primary profile at a distance of 5 microns from the mean surface. Smaller numbers indicate that the projecting peaks are spaced further apart than the peaks of a profile resulting in larger numbers.

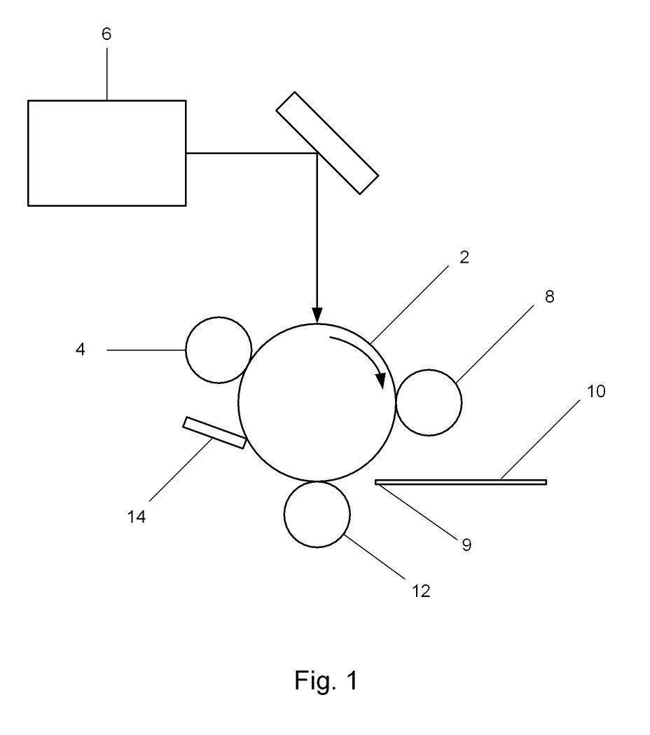

Additionally, all of the print-receptive surface parameters can be obtained in varying directions, for example, measurements can be obtained in a direction perpendicular to the leading edge 9 (FIG. 1) of the print-receptive medium. The print-receptive surface parameters can also be obtained in a direction parallel to the leading edge of the print-receptive medium. These directions are orthogonal to one another. As used herein, the direction perpendicular to the leading edge of the print-receptive medium is referred to as the machine direction or MD. As used herein, the direction parallel to the leading edge of the print-receptive medium is referred as the cross direction or CD.

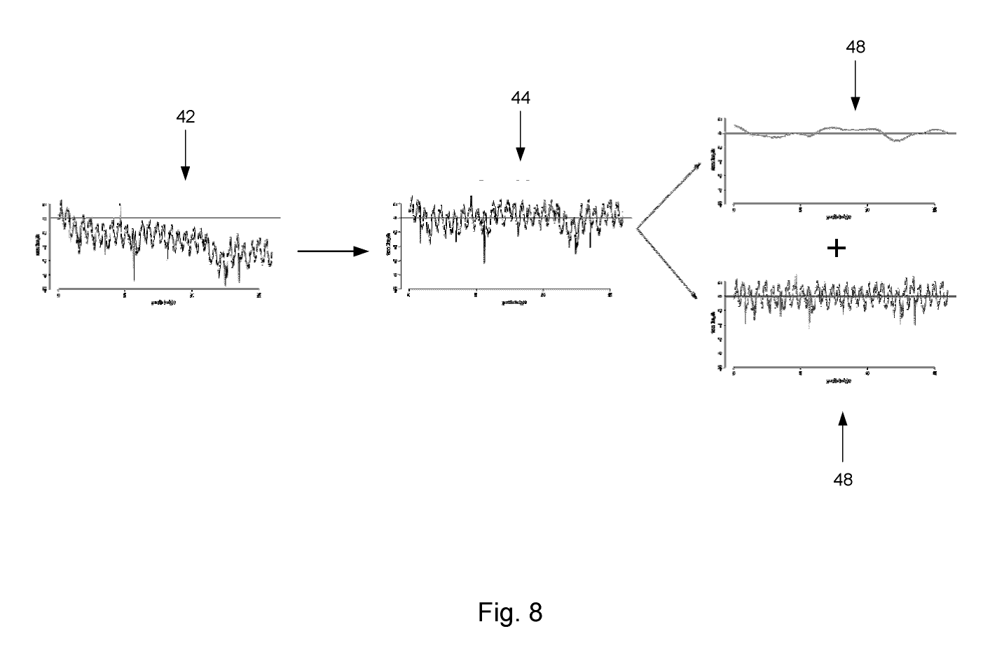

After removal of measurement noise from the raw surface profile 42, the surface profile 44, also known as the primary profile, can be broken into two components, specifically, the roughness profile 46 and the waviness profile 48. See FIG. 8. Referring back to FIG. 6, the roughness profile contains short-wavelength, high-frequency deviations from a mean, or average, surface 28. The mean surface is average height value of all the points on the particular profile of interest normalized to 0. The peak heights 24 are deviations from the mean surface in the direction away from the medium and the valley depths 26 are deviations from the mean surface in the direction toward the medium. The waviness profile contains long-wavelength, low-frequency deviations from the mean surface. A cutoff wavelength, or filter, specifies the wavelength that separates the roughness profile and the waviness profile. It should be noted that print-receptive surface parameters can be obtained for the primary profile, the roughness profile, and the waviness profile. Parameters that begin with “P,” for example Pp, are derived from the primary profile, while those that begin with “R” or “W” are from the roughness profile or the waviness profile, respectively.

Again referring to FIG. 6, Pp 38 is the height, above the mean surface 28, of the highest peak in the primary profile 44. Similarly, Pv 40 is the depth, below the mean surface, of the deepest valley in the primary profile. Both Pp and Pv are reported as positive numbers.

Pa is the arithmetic-mean deviation of the surface from the mean surface 28 in the primary profile 44. It is determined by averaging the absolute value of the difference of each point on the primary profile from the mean surface. Doubling the Pa value provides an estimate of the average depth from a peak to a valley.

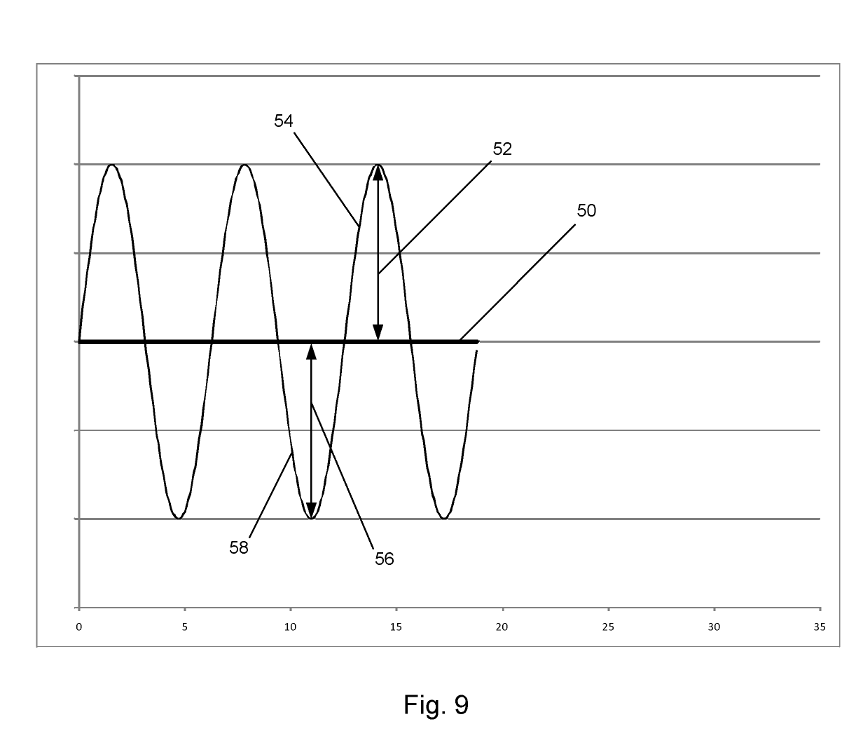

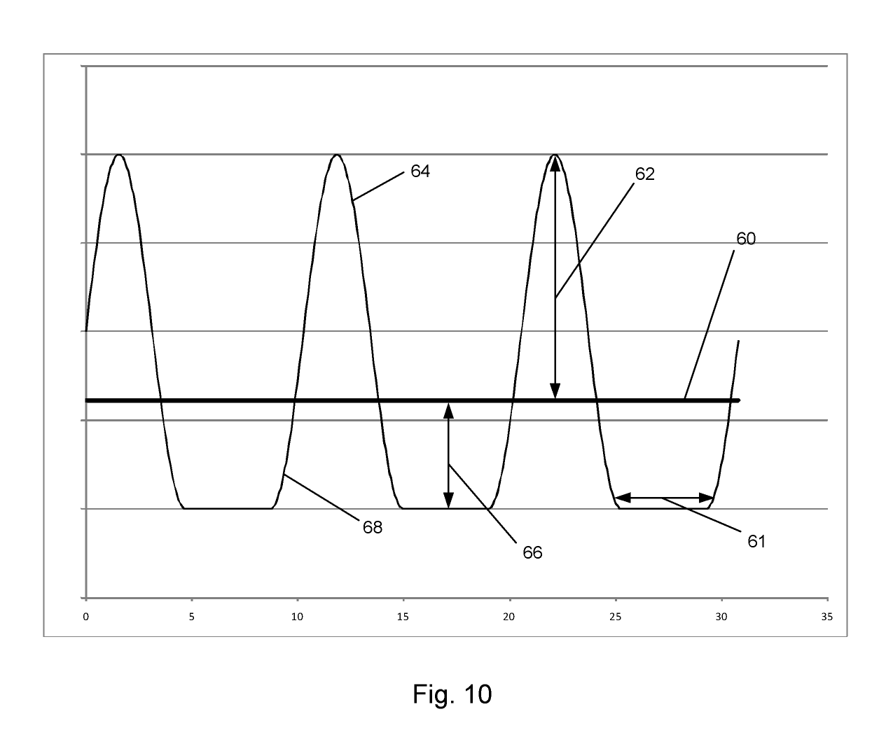

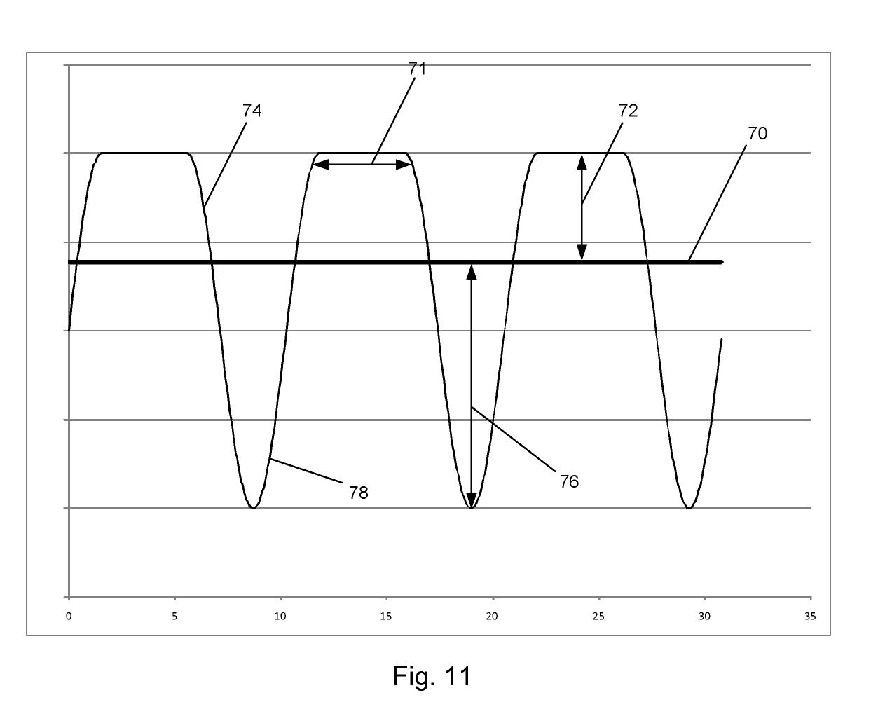

Ppm and Pvm are parameters determined by TRUESURF (ISO 13565-3 using the primary profile) and are the mean peak height and mean valley depth, respectively, based on the primary profile 44. Both are reported as positive numbers measured from the mean surface 28. A positive value for Ppm-Pvm indicates that the peaks 20 are taller 24 than the valleys 22 are deep 26, and that the peaks are narrower than the valleys. Conversely, a negative value for Ppm-Pvm indicates that the peaks are shorter than the valleys are deep, and the peaks are wider than the valleys. The value of Ppm-Pvm can be used to determine whether the surface can be thought of as evenly rough, a relatively smooth surface with peaks, or a relatively smooth surface with valleys. If the surface is thought of as a regular sine wave, for example, as shown in FIG. 9, the mean surface 50, which is the arithmetic mean of all the points, is the midpoint between the heights 52 of the peaks 54 and the depths 56 of the valleys 58. Thus, the peaks are as high above the mean surface as the valleys are deep below the mean surface, resulting in an evenly rough surface. In this case, Ppm-Pvm=0. Alternatively, if the regular sine wave were stretched such that only the valley portions were widened 61, as shown in FIG. 10, and the distance between the highest peak and the lowest valley is unchanged, the mean surface 60 would shift toward the valleys 68, since now there are more valley surface points. The peaks 64 would be higher 62 above the mean surface and the valleys would be less deep 66 compared to the regular sine wave surface. The surface would appear more like a relatively smooth surface with peaks. Alternatively, the surface can be thought of as having, on average, peaks that are narrower than the valleys. In this instance Ppm-Pvm>0. Conversely, if the regular sine wave were stretched such that only the peak portions were widened 71, as shown in FIG. 11, and the distance between the highest peak and the lowest valley is unchanged, the mean surface 70 would shift toward the peaks 74, since now there are more peak surface points. The peaks would be less high 72 above the mean surface and the valleys 78 would be deeper 76 compared to the regular sine wave surface. The surface would appear more like a relatively smooth surface with valleys. Alternatively, the surface can be thought of as having, on average, peaks that are wider than the valleys are narrow. In this instance Ppm-Pvm<0.

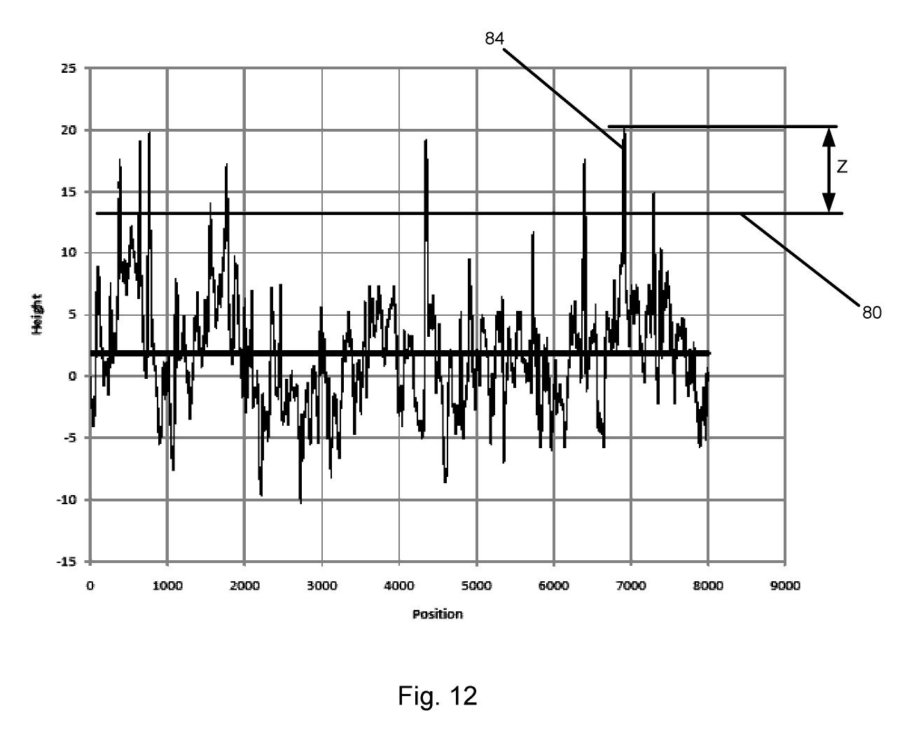

Another measure of the shape of the peaks can be determined by examining the fractional amount of material accounted for in the tops of the highest peaks found in the roughness profile. Referring back to FIG. 7, the relative amount of material, Tp % 34, is found from the Abbott-Firestone curve, which represents the fraction of material at a percentage of the distance z through the roughness profile. This is equivalent to determining the fraction of material versus air at a slicing plane 80 at a depth z as measured from the highest peak 84. See FIG. 12. Thus, when z=0, the slicing plane just touches the highest peak and the fraction of material at the slicing plane is 0%. When z=Pp+Pv, the slicing plane just touches the floor of the deepest valley and the fraction of material at the slicing plane is 100%. The fraction of material at depth z is defined as the bearing ratio at threshold z. At a given depth z, a surface with a smaller bearing ratio has narrower peaks on average than a surface with a higher bearing ratio, assuming the number of peaks is approximately the same.

One source of stray toner particles is from inefficient cleaning of the drum after an image is transferred to the surface of a print-receptive medium. Toner used in electrophotographic printing devices is generally in a dry, particulate form. Toner was obtained from an HP LASERJET 1320 printer cartridge (Hewlett-Packard Company, Palo Alto, Calif., USA), a Samsung ML-2510 printer cartridge (Samsung Electronics Company, Ltd., Seoul, Korea), and a Brother HL-5240 printer cartridge (Brother International Corporation, Nagoya, Japan) and the particle size distribution was determined. See TABLE I. In general, it appears that electrophotographic toner has a mean particle size between about 9 microns and about 10 microns. As used herein, the term “micron” means micrometer. The minimum particle size ranges between about 2 microns and about 3 microns, and the maximum particle size ranges between about 15 microns to about 18 microns. An unprinted sheet of print-receptive medium was passed through the HP LASERJET 1320 printer a single time and examined for transfer of stray toner particles. Stray toner particles were found and the particle size was estimated from the size of the toner spots on the sheet. It was found that the mean stray toner particle size was between about 6 microns and about 7 microns (HP LASERJET 1320 stray toner in TABLE I). The minimum particle size was about 1 micron and the maximum particle size was about 10 microns. As can be seen from TABLE I, the HP LASERJET 1320 toner particles from the cartridge are larger than the HP LASERJET 1320 stray toner particles deposited on the unprinted sheet of print-receptive medium after a single pass through the printer. It appears that larger toner particles are more easily removed from the drum in the cleaning process, resulting in primarily smaller stray toner particles remaining on the drum after cleaning.

TABLE I

| | Minimum | Maximum | Mean |
|---|---|---|---|
| | particle | particle | particle |
| Toner sample | size (microns) | size (microns) | size (microns) |
| HP LASERJET 1320 | 3.1 | 18.0 | 9.8 |
| Samsung ML-2510 | 2.6 | 15.5 | 9.7 |
| Brother HL-5240 | 2.5 | 16.3 | 9.3 |
| HP LASERJET 1320 | 0.9 | 9.7 | 6.6 |
| stray toner | | | |

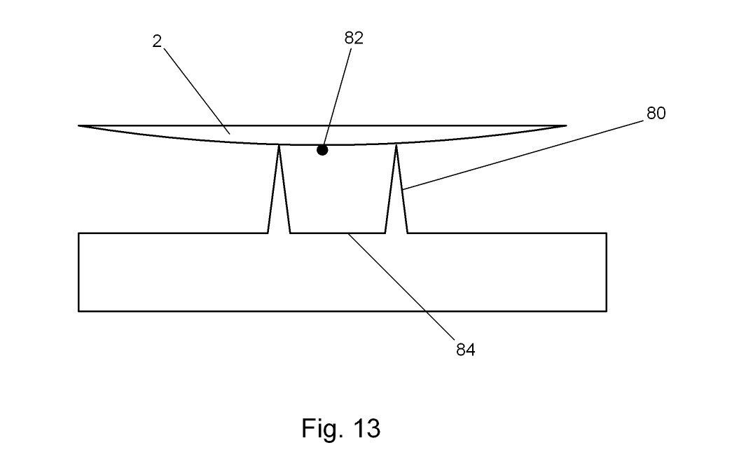

Stray toner particle transfer to a non-printed area of a print-receptive medium can occur because the surface of the print-receptive medium comes into contact with, or sufficiently close to, the drum 2 and rollers of the printer, picking up unwanted, stray toner particles. A print-receptive surface tends to pick up fewer stray toner particles after coming into contact with the rollers of an electrophotographic printer if the contact area of the print-receptive surface is reduced. Thus, the profile of the print-receptive surface plays a role in the transfer of stray toner particles. See FIG. 13. A print-receptive surface with relatively tall, narrow peaks 80 reduces the probability that a stray toner particle 82 will come into contact with a peak. With the relatively tall, narrow peaks spaced sufficiently far apart, the probability that a stray toner particle will come into contact with the relatively deep valley floors 84 is reduced. By reducing the probability that stray toner particles will contact the print-receptive surface, the transfer of stray toner particles to the print-receptive medium and subsequent graying of the print-receptive medium is reduced. Furthermore, if the print-receptive medium is further exposed to stray toner particles, for example, if the print-receptive medium is passed through a printer additional times, the probability of stray toner particle transfer to the print-receptive medium is reduced.

Based upon the observed toner particle size distribution in TABLE I, the bearing ratio at threshold 5 microns and the bearing ratio at threshold 10 microns were determined for a number of print-receptive medium surfaces. Competitive print-receptive media chosen were commercially available textured print-receptive media (including textured writing paper and printer papers modified to appear to have linen texture), commercially available laser print-receptive media, commercially available inkjet print-receptive media, and exemplary embodiments of the invention. Surface profile measurements were taken in both MD and CD. Textured Sample 1 (TS1) is HOWARD LINEN F-650 (Neenah Paper, Inc., Neenah, Wis., USA). Textured Sample 2 (TS2) is NEENAH LINEN 05321 from Neenah Paper, Inc. Textured Sample 3 (TS3) is FOX RIVER 701N from Neenah Paper, Inc. Textured Sample 4 (TS4) is SUNDANCE BRIGHT WHITE 04820 from Neenah Paper, Inc. Textured Sample 5 (TS5) is CAPITOL BOND B622 from Neenah Paper, Inc. Textured Sample 6 (TS6) is BECKET CAMBRIC 11395B (Mohawk Fine Papers, Inc., Cohoes, N.Y., USA). Textured Sample 7 (TS7) is STRATHMORE WRITING PAPER 11758C from Mohawk Fine Papers, Inc. Textured Sample 8 (TS8) is NEENAH LINEN 06051 from Neenah Paper, Inc. Laser Sample 1 (LS1) is 8218 laser grade paper (Domtar Corp., Montreal, Canada). Laser Sample 2 (LS2) is TRIO 134 uncoated laser paper from Domtar Corp. Laser Sample 3 (LS3) is a coated sample of TRIO 134 uncoated laser paper from Domtar Corp. Inkjet Sample 1 (IJ1) is 8234 inkjet paper from Domtar Corp. Inkjet Sample 2 (IJ2) is STAPLES BRIGHT WHITE INKJET PAPER 73332 (Staples, Inc., Framingham, Mass., USA). Inkjet Sample 3 (IL3) is FELIX SCHOELLER J80270 (Felix Schoeller Holding GmbH & Co., Osnabrueck, Germany). Examples 1-11 (EX1-EX11) are all coated samples of TRIO 134 uncoated laser paper from Domtar Corp. The coating process used for coating the LS3 and EX1-EX11 samples is described below. Surface parameters of all the samples are summarized in TABLE II. Note that in TABLE II, BR(10) is the bearing ratio at threshold 10 microns and BR(5) is the bearing ratio at threshold 5 microns.

TABLE II

| | | Pa | Pp | Ppm | Pvm | Pv | BR(10) | BR(5) | Ppm − Pvm | PHSC |
|---|---|---|---|---|---|---|---|---|---|---|
| | | (microns) | (microns) | (microns) | (microns) | (microns) | (%) | (%) | (microns) | (peaks/mm) |
| TS1 | CD | 6.02 | 18.58 | 14.62 | 18.35 | 22.75 | 12.60 | 1.83 | −3.73 | 0.50 |
| | MD | 6.02 | 19.04 | 16.66 | 20.14 | 23.78 | 12.64 | 2.52 | −3.49 | 1.05 |
| TS2 | CD | 5.12 | 18.89 | 13.75 | 15.22 | 17.92 | 8.32 | 1.88 | −1.47 | 0.59 |
| | MD | 5.51 | 15.26 | 13.91 | 15.51 | 20.07 | 22.31 | 5.33 | −1.60 | 1.96 |
| TS3 | CD | 7.29 | 22.94 | 19.74 | 24.38 | 28.46 | 7.89 | 2.44 | −4.64 | 0.75 |
| | MD | 8.11 | 25.52 | 19.88 | 24.74 | 30.07 | 6.56 | 1.94 | −4.86 | 0.50 |
| TS4 | CD | 8.86 | 23.41 | 20.66 | 24.03 | 30.10 | 10.47 | 3.76 | −3.37 | 1.25 |
| | MD | 8.57 | 26.24 | 21.26 | 23.39 | 28.32 | 6.66 | 1.93 | −2.13 | 0.67 |
| TS5 | CD | 7.14 | 20.84 | 16.72 | 22.92 | 28.20 | 12.06 | 3.40 | −6.20 | 0.84 |
| | MD | 6.03 | 19.97 | 16.43 | 19.39 | 22.58 | 11.67 | 2.83 | −2.96 | 0.84 |
| TS6 | CD | 4.46 | 12.82 | 11.04 | 17.09 | 21.52 | 34.29 | 7.86 | −6.05 | 3.46 |
| | MD | 4.03 | 14.65 | 9.81 | 12.84 | 16.04 | 32.00 | 4.32 | −3.03 | 1.21 |
| TS7 | CD | 7.49 | 24.17 | 20.66 | 25.68 | 35.57 | 8.78 | 3.03 | −5.03 | 0.75 |
| | MD | 8.58 | 26.07 | 21.21 | 24.49 | 27.06 | 6.82 | 2.31 | −3.28 | 0.71 |
| TS8 | CD | 5.90 | 19.16 | 15.74 | 15.86 | 19.85 | 14.07 | 3.70 | −0.12 | 0.46 |
| | MD | 5.57 | 14.83 | 12.23 | 15.80 | 18.68 | 31.88 | 10.43 | −3.57 | 1.83 |
| LS1 | CD | 2.99 | 9.01 | 7.07 | 15.64 | 22.38 | 66.08 | 14.26 | −8.57 | 5.13 |
| | MD | 3.62 | 9.90 | 7.25 | 16.48 | 21.94 | 58.75 | 18.76 | −9.23 | 5.92 |
| LS2 | CD | 3.02 | 10.99 | 8.63 | 11.36 | 14.90 | 45.42 | 5.29 | −2.73 | 3.42 |
| | MD | 3.18 | 8.76 | 8.23 | 10.58 | 13.47 | 67.07 | 20.99 | −2.36 | 5.84 |
| LS3 | CD | 3.57 | 12.89 | 9.38 | 11.63 | 13.87 | 28.97 | 4.07 | −2.26 | 1.34 |
| | MD | 3.19 | 10.87 | 9.21 | 8.99 | 10.78 | 43.21 | 10.15 | 0.23 | 2.71 |
| IJ1 | CD | 5.90 | 16.26 | 11.66 | 20.71 | 26.05 | 22.65 | 4.10 | −9.05 | 1.50 |
| | MD | 4.60 | 13.09 | 9.56 | 16.63 | 19.57 | 40.97 | 10.53 | −7.07 | 3.80 |
| IJ2 | CD | 3.07 | 10.04 | 8.14 | 13.81 | 18.68 | 58.43 | 8.72 | −5.67 | 4.04 |
| | MD | 3.46 | 9.34 | 8.08 | 11.96 | 17.23 | 60.64 | 18.27 | −3.89 | 6.67 |
| IJ3 | CD | 4.50 | 14.78 | 12.67 | 14.78 | 18.15 | 24.53 | 4.34 | −2.11 | 2.67 |
| | MD | 4.20 | 13.05 | 11.87 | 13.72 | 18.66 | 26.02 | 4.41 | −1.85 | 3.75 |
| EX 1 | CD | 4.60 | 23.02 | 18.20 | 11.85 | 14.31 | 1.95 | 0.78 | 6.35 | 0.38 |
| | MD | 4.22 | 18.84 | 15.43 | 12.26 | 14.86 | 3.80 | 0.88 | 3.17 | 0.50 |
| EX 2 | CD | 3.85 | 18.39 | 15.92 | 14.09 | 16.63 | 4.84 | 0.95 | 1.82 | 0.55 |
| | MD | 3.64 | 17.53 | 15.50 | 11.77 | 14.94 | 4.08 | 0.96 | 3.72 | 0.54 |
| EX 3 | CD | 4.68 | 23.32 | 17.18 | 11.31 | 13.13 | 2.56 | 0.82 | 5.87 | 0.34 |
| | MD | 4.20 | 16.43 | 12.58 | 11.83 | 16.12 | 10.51 | 1.79 | 0.75 | 0.92 |
| EX 4 | CD | 4.65 | 20.48 | 17.68 | 13.68 | 18.39 | 4.84 | 0.90 | 4.00 | 0.58 |
| | MD | 4.67 | 21.44 | 15.34 | 11.29 | 16.23 | 4.32 | 0.86 | 4.04 | 0.75 |
| EX 5 | CD | 4.32 | 19.79 | 16.66 | 13.95 | 16.47 | 5.53 | 1.26 | 2.71 | 0.75 |
| | MD | 4.62 | 20.53 | 16.48 | 12.11 | 17.09 | 5.80 | 1.75 | 4.37 | 1.25 |
| EX 6 | CD | 4.62 | 20.67 | 17.64 | 13.00 | 16.54 | 3.84 | 0.76 | 4.64 | 0.75 |
| | MD | 4.44 | 15.28 | 12.66 | 12.03 | 15.72 | 17.38 | 1.66 | 0.62 | 1.63 |
| EX 7 | CD | 4.25 | 18.79 | 15.71 | 11.01 | 13.10 | 6.69 | 0.84 | 4.71 | 0.71 |
| | MD | 5.14 | 17.59 | 14.21 | 11.22 | 14.98 | 11.47 | 1.78 | 2.99 | 1.09 |
| EX 8 | CD | 3.78 | 19.46 | 14.97 | 11.29 | 13.29 | 2.76 | 0.67 | 3.67 | 0.38 |
| | MD | 3.91 | 20.35 | 14.59 | 10.98 | 12.93 | 2.34 | 0.64 | 3.61 | 0.34 |
| EX 9 | CD | 3.78 | 15.50 | 12.17 | 11.67 | 13.39 | 14.88 | 1.27 | 0.51 | 1.09 |
| | MD | 3.63 | 14.90 | 11.20 | 9.79 | 11.59 | 14.00 | 1.42 | 1.41 | 1.17 |
| EX 10 | CD | 4.93 | 20.91 | 16.99 | 11.15 | 13.76 | 4.64 | 1.00 | 5.84 | 0.50 |
| | MD | 3.85 | 17.50 | 14.60 | 11.05 | 14.63 | 5.91 | 1.39 | 3.55 | 0.80 |
| EX 11 | CD | 4.54 | 19.26 | 16.96 | 11.92 | 13.99 | 4.82 | 0.93 | 5.05 | 0.54 |
| | MD | 4.39 | 21.23 | 15.00 | 11.47 | 14.96 | 3.28 | 1.51 | 3.52 | 0.59 |

### EXAMPLES

### Roughness Measurement

### Sample Preparation:

Samples are cut from a random location in the machine direction (MD) or cross direction (CD) of the print-receptive media. Samples are rectangular, measuring 7 cm×1 cm, with the 7 cm direction aligned with the indicated direction of the web. Each sample is mounted onto a glass microscope slide using SCOTCH 665 permanent double sided tape (3M, St. Paul, Minn., USA) in such a way as to avoid bubbles underneath the sample.

### Data Collection:

Roughness measurements are recorded using a DEKTAK 8 profilometer (Veeco Instruments, Inc., Plainview, N.Y., USA) equipped with a 5 microns radius stylus. The measurement is performed using 5 mg force, a measurement range of 2620 kilo angstrom, and a profile setting of “hills and valleys.” The scan length is 8 mm and resolution of about 0.513 micron. Each scan takes about 52 seconds to collect a total number of 15600 data points. Each direction (CD and MD) of the print-receptive medium is measured in three locations, and the average of the three locations is reported for each direction.

### Data Analysis:

The raw scan data from DEKTAK 8 profilometer is saved in .dat format. The raw data file is opened using TRUESURF (TrueGage Surface Metrology, North Huntingdon, Pa., USA) for analysis. The TRUESURF software complies with ASME B46.1, ISO 4287, ISO 4288, ISO 12085, ISO 13565, and ISO 1302 standards. First, baseline correction was performed to remove the baseline slope. Linear least squares analysis was computed using the raw data. The linear baseline is then subtracted from the raw profile to obtain the primary profile. The TRUESURF software calculates values for Pp, Pv, Pa, Ppm, and Pvm. When the TRUESURF software is used to calculate the bearing ratio, the software first calculates the total depth, i.e. Pp+Pv. The material percentage, i.e. the bearing ratio, is then calculated at each 1% increase in depth starting at 0% and ending at 100% of the total depth. The result is a table in which the first column is the depth (in %) and the second column is the percentage of material. The percent depth is manually converted into the true depth (in microns) based upon Pp+Pv. Linear interpolation is used to determine the bearing ratio at threshold 5 microns and at threshold 10 microns from the true depth.

### Coating Formulations:

Formulations are summarized in TABLE III. The formulations were compounded using pre-blended mixtures as follows:

Mixture I: 100 parts by weight of water is mixed with 2 parts by weight of isopropyl alcohol (IPA) in a mixer capable of high shear mixing. Under high shear (the mixer running at 1000 rpm), 40 parts by weight of polyamide ORGASOL 1002D NAT (Arkema, Inc., Philadelphia, Pa., USA) is gradually added. After the ORGASOL 1002D NAT is dispersed, 5 parts by weight of IPA is sprayed onto the top of the dispersion to reduce foaming and then mixed in to the dispersion. The resulting dispersion is about 27.21% solids by weight.

Mixture II: 100 parts by weight of water is added to a mixer capable of medium shear mixing. Under medium shear (the mixer operating at 500 rpm) 80 parts by weight of SYLOID W900 silica (W.R. Grace and Company, Columbia, Md., USA) is gradually added. Mixing is continued until the silica is uniformly dispersed. The resulting dispersion is about 20% solids by weight.

Mixture III: A solution of 1 part by weight TRADEWINDS table salt (Amerifoods Trading Co., Los Angeles, Calif., USA) and 4 parts water is prepared. The mixture is stirred until the table salt is dissolved. The resulting solution is about 20% table salt by weight.

Mixture IV: 1 part by weight POLYPHOBE TR-115 (Coatex, Inc., Chester, S.C., USA) is diluted with 1 part by weight water and thoroughly mixed. The resulting mixture is about 20% solids by weight. Mixture IV is used as a thickener.

Mixture V: 1 part by weight of 28-30% ammonium hydroxide (NH₄OH) (Avantor Performance Materials, Phillipsburg, N.J., USA) is diluted with 3 parts by weight water and thoroughly mixed. The resulting solution is about 7% NH₄OH by weight.

Mixture VI: 1 part by weight of BYK 420 (Altana AG, Wesel, Germany) and 3 parts N-methyl-pyrrolidone (NMP) (Sigma-Aldrich Corp., St. Louis, Mo., USA) are thoroughly mixed to form a dilute solution. The resulting solution is about 13% solids by weight. Mixture VI is used as a thickener.

Coating formulations for the samples LS3 and EX1-EX11 are shown in TABLE III. Materials are added sequentially, from left to right in TABLE IV, and thoroughly mixed after each addition. The amount of each material to be added is listed in parts by weight. 100 parts by weight of polyvinyl acetate RESYN 5763 (Celanese Corporation, Dallas, Tex., USA) is thoroughly blended at ambient temperature with the amount of water, by weight, listed in the table. Each subsequent material is thoroughly mixed before the next material is added. After the final ingredient is added and thoroughly mixed, the formulation is moved to a coater for application to a substrate.

TABLE III

| | Formulation | | | | | | | | |
|---|---|---|---|---|---|---|---|---|---|
| Trial | Resyn | | | Mixture | Mixture | Mixture | | Mixture | Final % |
| Number | 5763 | Water | Mixture I | II | III | IV | Mixture V | VI | Solid |
| LS1 | 100 | 71.43 | 0.00 | 0.00 | 8.75 | 0.00 | 0.00 | 0.00 | 31.50% |
| EX 1 | 100 | 162.50 | 13.75 | 13.13 | 8.75 | 7.25 | 11.00 | 0.00 | 20.46% |
| EX 2 | 100 | 46.72 | 13.75 | 13.12 | 8.75 | 3.65 | 7.29 | 0.00 | 33.12% |
| EX 3 | 100 | 64.29 | 27.50 | 13.13 | 8.75 | 0.38 | 3.41 | 0.00 | 30.34% |
| EX 4 | 100 | 164.29 | 27.50 | 13.13 | 8.75 | 0.38 | 3.41 | 0.00 | 21.19% |
| EX 5 | 100 | 71.43 | 27.50 | 13.13 | 8.75 | 0.00 | 0.00 | 0.00 | 30.43% |
| EX 6 | 100 | 64.29 | 55.00 | 13.13 | 8.75 | 0.38 | 3.84 | 1.45 | 30.50% |
| EX 7 | 100 | 64.29 | 0.00 | 26.26 | 8.75 | 0.00 | 0.00 | 0.00 | 31.11% |
| EX 8 | 100 | 57.14 | 0.00 | 52.51 | 8.75 | 0.00 | 0.00 | 0.00 | 30.79% |
| EX 9 | 100 | 64.29 | 0.00 | 13.13 | 8.75 | 0.38 | 3.13 | 1.00 | 31.25% |
| EX 10 | 100 | 35.71 | 0.00 | 105.03 | 8.75 | 0.00 | 0.00 | 0.00 | 31.17% |
| EX 11 | 100 | 71.43 | 27.50 | 0.00 | 8.75 | 0.00 | 0.00 | 0.00 | 31.09% |

Coating: A roll of TRIO 143 paper is loaded onto a coater such that the outside of the roll will be coated upon. The coater speed (feet per minute), the type of coating method, and coat weight (grams per square meter) for the Laser 3 and Examples 1-11 samples is listed in TABLE IV. The coated substrate passed through a convection oven for drying. The oven temperature is adjusted such that the coated substrate is dry after emerging from the oven. The exact temperature will depend on the coat weight of the coating formulation and the speed of the coater. Upon exiting the oven, the coated substrate passes through a steam foil for remoisturization (to ensure the coated substrate lays flat when sheeted into print-receptive media) rolled into a roll and removed from the coater. The finished roll is subsequently converted into the desired print-receptive media.

TABLE IV

| | | | Coater | |
|---|---|---|---|---|
| Trial | | | Speed | Coat Weight |
| Number | Type of Coating | Gravure Setting | (fpm) | (gsm) |
| LS1 | Gravure Coating | 85 ME (25.5 bcm) | 100 | 4.5 |
| EX1 | Slot Die | NA | 50 | 4.8 |
| EX2 | Curtain | NA | 1500 | 7.8 |
| EX3 | Gravure Coating | 85 ME (25.5 bcm) | 100 | 5.6 |
| EX4 | Gravure Coating | 85 ME (25.5 bcm) | 100 | 2.9 |
| EX5 | Gravure Coating | 85 ME (25.5 bcm) | 100 | 4.7 |
| EX6 | Gravure Coating | 85 ME (25.5 bcm) | 100 | 5.3 |
| EX7 | Gravure Coating | 85 ME (25.5 bcm) | 100 | 5.4 |
| EX8 | Gravure Coating | 85 ME (25.5 bcm) | 100 | 5.4 |
| EX9 | Gravure Coating | 85 ME (25.5 bcm) | 100 | 4.5 |
| EX10 | Gravure Coating | 85 ME (25.5 bcm) | 100 | 4.7 |
| EX11 | Gravure Coating | 85 ME (25.5 bcm) | 100 | 5.3 |

In particular, the bearing ratio at threshold 5 microns values for all competitive samples (TS1-TS8, LS1-LS3, and IJ1-IJ3) were greater than about 1.83%. In contrast, all the exemplary embodiments, EX1-EX11, have bearing ratio at 5 microns values of less than or equal to about 1.79% and greater than or equal to about 0.64%. Even at threshold 10 microns the exemplary embodiments EX1, EX2, EX4, EX5, EX8, EX10, and EX11 have bearing ratio values less than or equal to about 5.91% and greater than about 1.95%, while the values of the competitive samples are all greater than about 6.56%. The results show that the exemplary embodiments EX1-EX11 have peaks on the print-receptive surface that are narrower or thinner than peaks on the print-receptive surface of commercially available print-receptive media (TS1-TS8, LS1-LS3, and IJ1-IJ3). Specifically, exemplary embodiments EX1-EX11 have peaks on the print-receptive surface with bearing ratio at threshold 5 microns less than or equal to about 1.79% and greater than or equal to about 0.64%, and/or peaks on the print-receptive surface with bearing ratio at threshold 10 microns of less than or equal to about 5.91% and greater than or equal to about 1.95%.

As mentioned previously, doubling Pa provides an estimate of the average depth from peak-to-valley on the print-receptive surface, since Pa is a measure of the average distance of all points on the print-receptive surface profile from the mean surface profile. TABLE II includes Pa data for a variety of commercially available print-receptive media and exemplary embodiments. The Pa results show that, in general, the Textured Sample print-receptive media (TS1-TS8) have a greater average depth from peak-to-valley than non-textured print-receptive media (LS1-LS3, IJ1-IJ3, and EX1-EX11). Textured Sample print-receptive media (TS1-TS8) have Pa values that range from about 4.03 microns to about 8.86 microns. Laser Sample print-receptive media (LS1-LS3) have Pa values ranging from about 2.99 microns to about 3.62 microns and Inkjet Sample print-receptive media (IJ1-IJ3) have Pa values ranging from about 3.07 microns to about 5.90 microns. The exemplary embodiments (EX1-EX11) have Pa values ranging from about 3.63 microns to about 5.14 microns.

TABLE II also shows the values of Ppm-Pvm for commercially available samples and exemplary embodiments. In all cases, the values of Ppm-Pvm for the commercially available samples (TS1-TS8, LS1-LS3, and IJ1-IJ3) are less than about 0.23 micron. The commercially available samples (TS1-TS8 LS1, LS2 LS3 (CD), and IJ1-IJ3) have Ppm-Pvm values that are less than about −0.12 micron, indicating that these print-receptive surfaces have, on average, relatively wide peaks and narrow valleys. The exemplary embodiments, EX1-EX11, have Ppm-Pvm values that are greater than or equal to about 0.51 micron. In contrast to the commercially available samples (TS1-TS8, LS1-LS3, and IJ1-IJ3), the exemplary embodiments (EX1-EX11) have, relatively narrow peaks and wide valleys.

TABLE II also shows the values for PHSC for a variety of commercially available print-receptive media and exemplary embodiments. Textured Sample print-receptive media (TS1-TS8) have PHSC values that range from about 0.46 peaks/mm to about 3.46 peaks/mm. Laser Sample print-receptive media (LS1-LS3) have PHSC values ranging from about 1.34 peaks/mm to about 5.92 peaks/mm and Inkjet Sample print-receptive media (IJ1-IJ3) have PHSC values ranging from about 1.50 peaks/mm to about 6.67 peaks/mm. The exemplary embodiments (EX1-EX11) have PHSC values ranging from about 0.34 peaks/mm to about 1.63 peaks/mm.

TABLE V shows the data from TABLE II wherein the reported values for the print-receptive surface parameters are the average of the CD and MD values. The average bearing ratio at threshold 5 microns values show that all the commercially available print-receptive media (TS1-TS8, LS1-LS3, and IJ1-IJ3) have values greater than about 2.18% and all the exemplary embodiments EX1-EX11 have values less than or equal to about 1.51% and greater than or equal to about 0.66%. At average bearing ratio at threshold 10 microns, the exemplary embodiments EX1-EX5, EX8, EX10, and EX11 have values less than or equal to about 6.54% and greater than or equal to about 2.55%, while all the commercially available print-receptive media (TS1-TS8, LS1-LS3, and IJ1-IJ3) have values greater than about 7.23%.

TABLE V

| | Pa | Pp | Ppm | Pvm | Pv | BR(10) | BR(5) | Ppm − Pvm | |
|---|---|---|---|---|---|---|---|---|---|
| | (microns) | (microns) | (microns) | (microns) | (microns) | (%) | (%) | (microns) | ΔE*_{ab} |
| TS1 | 6.02 | 18.81 | 15.64 | 19.25 | 23.26 | 12.62 | 2.18 | −3.61 | 2.91 |
| TS2 | 5.32 | 17.07 | 13.83 | 15.37 | 18.99 | 15.32 | 3.61 | −1.54 | 3.39 |
| TS3 | 7.70 | 24.23 | 19.81 | 24.56 | 29.26 | 7.23 | 2.19 | −4.75 | 2.41 |
| TS4 | 8.72 | 24.82 | 20.96 | 23.71 | 29.21 | 8.57 | 2.85 | −2.75 | 1.89 |
| TS5 | 6.59 | 20.41 | 16.58 | 21.15 | 25.39 | 11.86 | 3.12 | −4.58 | 1.91 |
| TS6 | 4.25 | 13.73 | 10.42 | 14.96 | 18.78 | 33.15 | 6.09 | −4.54 | 2.78 |
| TS7 | 8.04 | 25.12 | 20.93 | 25.09 | 31.31 | 7.80 | 2.67 | −4.15 | 1.68 |
| TS8 | 5.73 | 16.99 | 13.98 | 15.83 | 19.26 | 22.98 | 7.07 | −1.85 | 3.04 |
| LS1 | 3.30 | 9.45 | 7.16 | 16.06 | 22.16 | 62.42 | 16.51 | −8.90 | 9.07 |
| LS2 | 3.10 | 9.87 | 8.43 | 10.97 | 14.19 | 56.25 | 13.14 | −2.54 | 6.12 |
| LS3 | 3.38 | 11.88 | 9.30 | 10.31 | 12.33 | 36.09 | 7.11 | −1.01 | 2.96 |
| IJ1 | 5.25 | 14.67 | 10.61 | 18.67 | 22.81 | 31.81 | 7.32 | −8.06 | 7.30 |
| IJ2 | 3.27 | 9.69 | 8.11 | 12.89 | 17.95 | 59.54 | 13.50 | −4.78 | 3.72 |
| IJ3 | 4.35 | 13.92 | 12.27 | 14.25 | 18.40 | 25.28 | 4.38 | −1.98 | 3.50 |
| EX 1 | 4.41 | 20.93 | 16.82 | 12.06 | 14.58 | 2.88 | 0.83 | 4.76 | 1.01 |
| EX 2 | 3.75 | 17.96 | 15.71 | 12.93 | 15.78 | 4.46 | 0.96 | 2.77 | 1.27 |
| EX 3 | 4.44 | 19.88 | 14.88 | 11.57 | 14.63 | 6.54 | 1.31 | 3.31 | 0.64 |
| EX 4 | 4.66 | 20.96 | 16.51 | 12.49 | 17.31 | 4.58 | 0.88 | 4.02 | 0.93 |
| EX 5 | 4.47 | 20.16 | 16.57 | 13.03 | 16.78 | 5.67 | 1.51 | 3.54 | 0.64 |
| EX 6 | 4.53 | 17.98 | 15.15 | 12.52 | 16.13 | 10.61 | 1.21 | 2.63 | 0.89 |
| EX 7 | 4.70 | 18.19 | 14.96 | 11.11 | 14.04 | 9.08 | 1.31 | 3.85 | 1.32 |
| EX 8 | 3.84 | 19.90 | 14.78 | 11.14 | 13.11 | 2.55 | 0.66 | 3.64 | 0.93 |
| EX 9 | 3.71 | 15.20 | 11.69 | 10.73 | 12.49 | 14.44 | 1.35 | 0.96 | 1.27 |
| EX 10 | 4.39 | 19.21 | 15.79 | 11.10 | 14.19 | 5.28 | 1.20 | 4.70 | 1.21 |
| EX 11 | 4.47 | 20.25 | 15.98 | 11.69 | 14.48 | 4.05 | 1.22 | 4.28 | 0.98 |

The average values for Pa in TABLE V show that the Textured Sample print-receptive media, TS1-TS8, tend to have larger peak-to-valley distances than non-textured print-receptive media. Specifically, Textured Sample print-receptive media (TS1-TS8) have Pa values that range from about 4.25 microns to about 8.72 microns. Laser Sample print-receptive media (LS1-LS3) have Pa values that range from about 3.10 microns to about 3.38 microns, and Inkjet Sample print-receptive media (IJ1-IJ3) have Pa values that range from about 3.27 microns to about 5.25 microns. The exemplary embodiments, EX1-EX11, have Pa values that range from about 3.71 microns to about 4.70 microns.

The average values for Ppm-Pvm in TABLE V show that all the exemplary embodiments, EX1-EX11, have values greater than or equal to about 0.96 micron and less than or equal to about 4.76 microns. All the commercially available print-receptive media (TS1-TS8, LS1-LS3, IJ1-IJ3)) have Ppm-Pvm values that are less than about −1.01 microns.

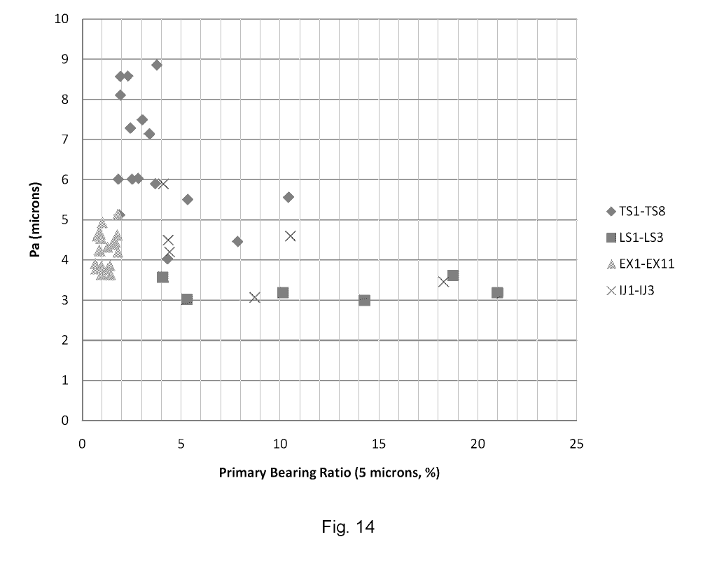

FIG. 14 plots values of Pa from TABLE II (both CD and MD) against the primary bearing ratio at threshold 5 microns (both CD and MD). Specifically, it can be seen that all the exemplary embodiments, EX1-EX11, regardless of their Pa values, have primary bearing ratio at threshold 5 microns values less than about 1.83%. Even more specifically all exemplary embodiments, EX1-EX11, regardless of their Pa values, have primary bearing ratio at threshold 5 microns values less than or equal to about 1.79%. Even more specifically all exemplary embodiments, EX1-EX11, regardless of their Pa values, have primary bearing ratio at threshold 5 microns values less than or equal to about 1.79% and greater than or equal to about 0.64%. Additionally, exemplary embodiments, EX1-EX6 and EX8-EX11, have primary bearing ratio at threshold 5 microns values less than about 4.07% and Pa values less than about 5.12 microns. Even more specifically, all exemplary embodiments, EX1-EX11, have primary bearing ratio at threshold 5 microns values less than or equal to about 1.79% and Pa values less than about 5.14 microns. Even more specifically, all exemplary embodiments, EX1-EX11, have primary bearing ratio at threshold 5 microns values less than or equal to about 1.79% and greater than or equal to about 0.64%, and Pa values less than or equal to about 5.14 microns and greater than or equal to about 3.63 microns.

FIG. 15 is similar to FIG. 14, except that values of Pa and primary bearing ratio at threshold 5 microns are the average of the CD and MD values. Specifically, it can be seen from FIG. 15 and TABLE V that all the exemplary embodiments, EX1-EX11, regardless of their average Pa values, have average primary bearing ratios at threshold 5 microns less than about 2.18%. Even more specifically all exemplary embodiments, EX1-EX11, regardless of their average Pa values, have average primary bearing ratios at threshold 5 microns less than or equal to about 1.51%. Even more specifically all exemplary embodiments, EX1-EX11, regardless of their average Pa values, have average primary bearing ratios at threshold 5 microns less than or equal to about 1.51% and greater than or equal to about 0.66%. Additionally, all exemplary embodiments, EX1-EX11, have average primary bearing ratios at threshold 5 microns less than about 4.38% and average Pa values less than about 5.32 microns. Specifically, all exemplary embodiments, EX1-EX11, have average primary bearing ratios at threshold 5 microns less than or equal to about 1.51% and average Pa values less than or equal to about 4.70 microns. Even more specifically, all exemplary embodiments, EX1-EX11, have average primary bearing ratios at threshold 5 microns less than or equal to about 1.51% and greater than or equal to about 0.66%, and average Pa values less than or equal to about 4.70 microns and greater than or equal to about 3.75 microns.

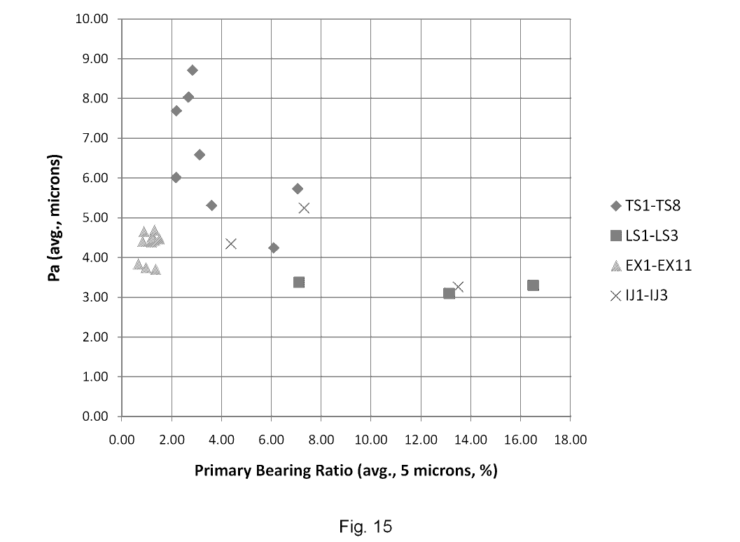

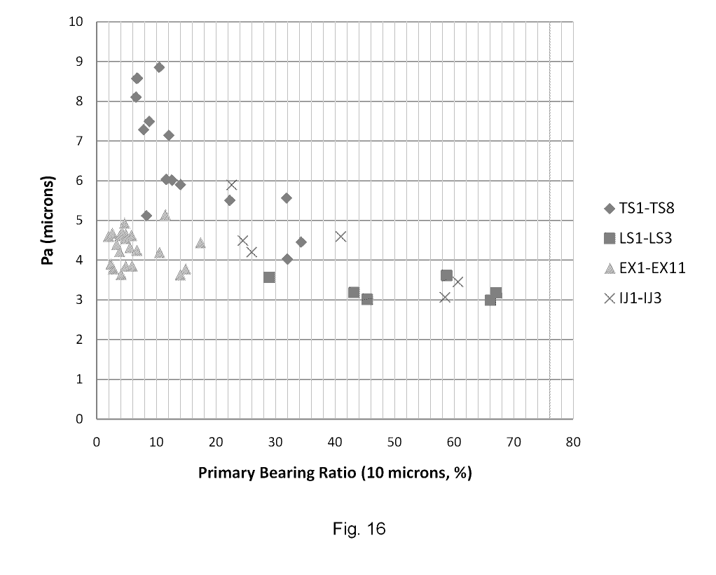

FIG. 16 plots values of Pa (both CD and MD) against the primary bearing ratio at threshold 10 microns (both CD and MD). Specifically, it can be seen from FIG. 16 and TABLE II that the exemplary embodiments, EX1-EX6 and EX8-EX11, have values of Pa less than about 5.12 microns and primary bearing ratio at threshold 10 microns values less than about 24.53%. More specifically, the exemplary embodiments, EX1-EX6 and EX8-EX11, have values of Pa less than or equal to about 4.93 microns and primary bearing ratio at threshold 10 microns values less than or equal to about 17.38%. Even more specifically, the exemplary embodiments, EX1-EX6 and EX8-EX11, have values of Pa less than or equal to about 4.93 microns and greater than or equal to about 3.63 microns, and primary bearing ratio at threshold 10 microns values less than or equal to about 17.38% and greater than or equal to about 1.95%.

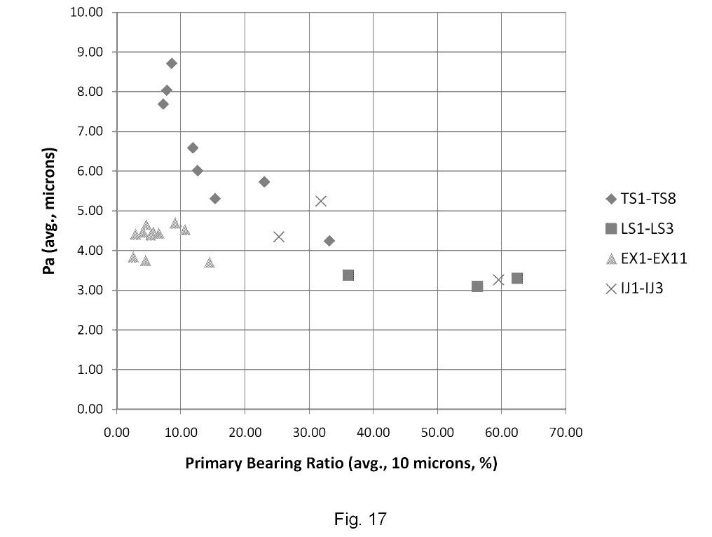

FIG. 17 is similar to FIG. 16, except that the values of Pa and primary bearing ratio at threshold 10 microns are the average of the CD and MD values. Specifically, it can be seen from FIG. 17 and TABLE V that the exemplary embodiments, EX1-EX5, EX8, EX10, and EX11, have average primary bearing ratios at threshold 10 microns less than about 7.23%. Even more specifically the exemplary embodiments, EX1-EX5, EX8, EX10, and EX11, have average primary bearing ratios at threshold 10 microns less than or equal to about 6.54%. Even more specifically the exemplary embodiments, EX1-EX5, EX8, EX10, and EX11, have average primary bearing ratios at threshold 10 microns less than or equal to about 6.54%, and greater than or equal to about 2.55%. Additionally, all exemplary embodiments, EX1-EX11, have average primary bearing ratios at threshold 10 microns less than about 25.28% and average Pa values less than about 5.32 microns. Specifically, all exemplary embodiments, EX1-EX11, have average primary bearing ratios at threshold 10 microns less than or equal to about 14.44% and average Pa values less than or equal to about 4.70 microns. Even more specifically, all exemplary embodiments, EX1-EX11, have average primary bearing ratios at threshold 10 microns less than or equal to about 14.44% and greater than or equal to about 2.55%, and average Pa values less than or equal to about 4.70 microns and greater than or equal to about 3.75 microns.

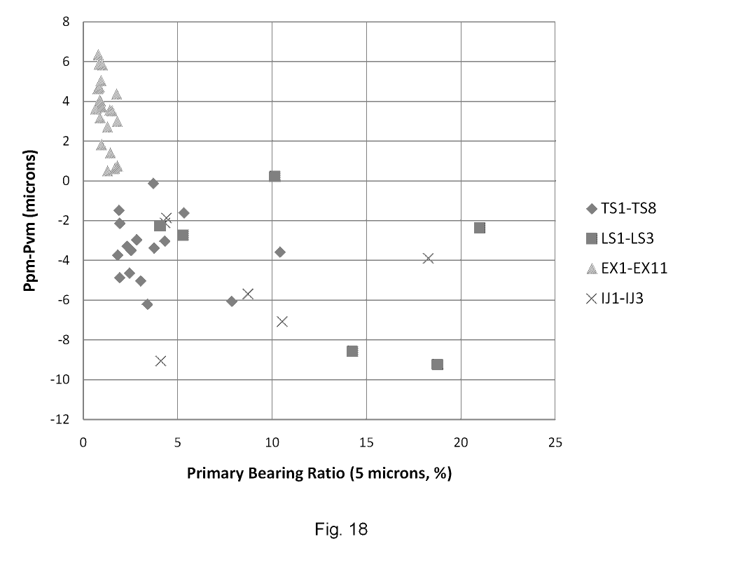

FIG. 18 plots values of Ppm-Pvm (both CD and MD) against the primary bearing ratio at threshold 5 microns (both CD and MD). Specifically, it can be seen from FIG. 18 and TABLE II that all the exemplary embodiments, EX1-EX11, regardless of their Ppm-Pvm values, have primary bearing ratio at threshold 5 microns values less than about 1.83%. Even more specifically all exemplary embodiments, EX1-EX11, regardless of their Ppm-Pvm values, have primary bearing ratio at threshold 5 microns values less than or equal to about 1.79%. Even more specifically all exemplary embodiments, EX1-EX11, regardless of their Ppm-Pvm values, have primary bearing ratio at threshold 5 microns values less than or equal to about 1.79% and greater than or equal to about 0.64%. Additionally, all exemplary embodiments, EX1-EX11, regardless of their primary bearing ratio at threshold 5 microns values, have Ppm-Pvm values greater than about 0.23 micron, and specifically, greater than or equal to about 0.51 micron. Even more specifically, all exemplary embodiments, EX1-EX11, regardless of their primary bearing ratio at threshold 5 microns values, have Ppm-Pvm values greater than or equal to about 0.51 micron and less than or equal to about 6.35 microns. Furthermore, all exemplary embodiments, EX1-EX11, have primary bearing ratio at threshold 5 microns values less than about 10.15% and Ppm-Pvm values greater than about −0.12 micron, specifically, primary bearing ratio at threshold 5 microns values less than or equal to about 1.79% and Ppm-Pvm values greater than or equal to about 0.51 micron. Even more specifically, all exemplary embodiments, EX1-EX11, have primary bearing ratio at threshold 5 microns values less than or equal to about 1.79% and greater than or equal to about 0.64%, and Ppm-Pvm values greater than or equal to about 0.51 micron and less than or equal to about 6.35 microns.

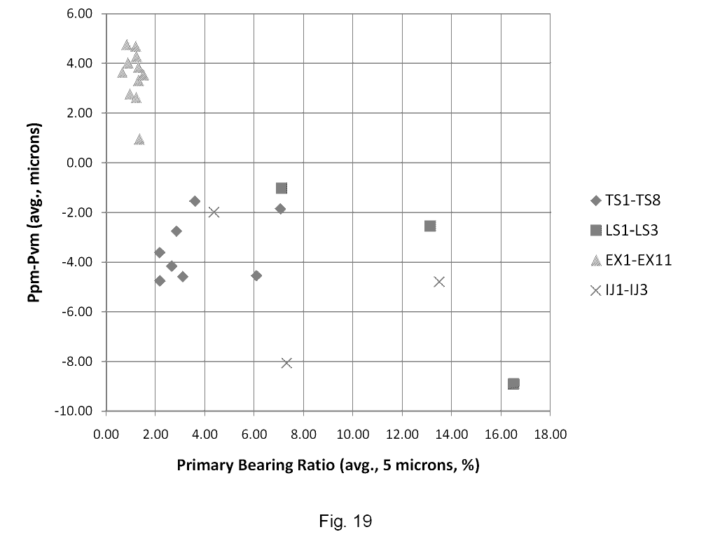

FIG. 19 is similar to FIG. 18, except that values of Ppm-Pvm and primary bearing ratio at threshold 5 microns are the average of the CD and MD values. Specifically, it can be seen from FIG. 19 and TABLE V that all the exemplary embodiments, EX1-EX11, regardless of their average Ppm-Pvm values, have average primary bearing ratio at threshold 5 microns values less than about 2.18%. Even more specifically all exemplary embodiments, EX1-EX11, regardless of their average Ppm-Pvm values, have average primary bearing ratio at threshold 5 microns values less than or equal to about 1.51%. Even more specifically all exemplary embodiments, EX1-EX11, regardless of their average Ppm-Pvm values, have average primary bearing ratio at threshold 5 microns values less than or equal to about 1.51% and greater than or equal to about 0.66%. Additionally, all exemplary embodiments, EX1-EX11, regardless of their average primary bearing ratio at threshold 5 microns values, have average Ppm-Pvm values greater than about −1.01 microns, and specifically, greater than or equal to about 0.96 micron. More specifically, all exemplary embodiments, EX1-EX11, regardless of their average primary bearing ratio at threshold 5 microns values, have average Ppm-Pvm values greater than about 0.96 micron and less than or equal to about 4.76 microns. Furthermore, all exemplary embodiments, EX1-EX11, have average primary bearing ratio at threshold 5 microns values less than about 7.11% and average Ppm-Pvm values greater than about −1.54 microns, specifically, average primary bearing ratio at threshold 5 microns values less than or equal to about 1.51% and average Ppm-Pvm values greater than or equal to about 0.96 micron. Even more specifically, all exemplary embodiments, EX1-EX11, have average primary bearing ratio at threshold 5 microns values less than about 1.51% and greater than or equal to about 0.66%, and average Ppm-Pvm values greater than or equal to about 0.96 micron and less than or equal to about 4.76 microns.

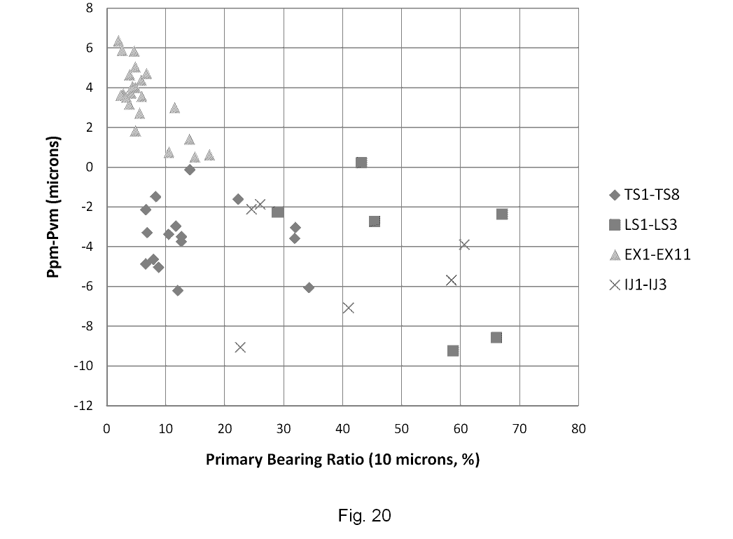

FIG. 20 plots values of Ppm-Pvm (both CD and MD) against the primary bearing ratio at threshold 10 microns (both CD and MD). Specifically, it can be seen from FIG. 20 and TABLE II that all of the exemplary embodiments, EX1-EX11, regardless of their primary bearing ratio at threshold 10 microns values, have Ppm-Pvm values greater than about 0.23 micron. Even more specifically, all of the exemplary embodiments, EX1-EX11, regardless of their primary bearing ratio at threshold 10 microns values, have Ppm-Pvm values greater than or equal to about 0.51 micron. Even more specifically, all of the exemplary embodiments, EX1-EX11, regardless of their primary bearing ratio at threshold 10 microns values, have Ppm-Pvm values greater than or equal to about 0.51 micron and less than or equal to about 6.35 microns. Additionally, all of the exemplary embodiments, EX1-EX11, have Ppm-Pvm values greater than about 0.23 micron and primary bearing ratio at threshold 10 microns values less than about 43.21%. Specifically, all of the exemplary embodiments, EX1-EX11, have Ppm-Pvm values greater than or equal to about 0.51 micron and primary bearing ratio at threshold 10 microns values less than or equal to about 17.38%. Even more specifically, all of the exemplary embodiments, EX1-EX11, have Ppm-Pvm values greater than or equal to about 0.51 micron and less than or equal to about 6.35 microns, and primary bearing ratio at threshold 10 microns values less than or equal to about 17.38% and greater than or equal to about 1.95%.

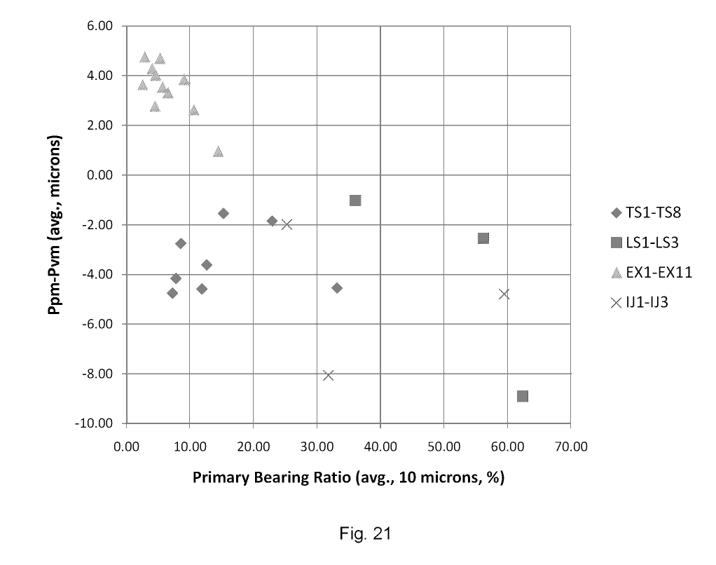

FIG. 21 is similar to FIG. 20, except that values of Ppm-Pvm and primary bearing ratio at threshold 10 microns are the average of the CD and MD values. Specifically, it can be seen from FIG. 21 and TABLE V that all exemplary embodiments, EX1-EX11, regardless of their average primary bearing ratio at threshold 10 microns values, have average Ppm-Pvm values greater than about −1.01 microns, and specifically, greater than or equal to about 0.96 micron. Even more specifically, all exemplary embodiments, EX1-EX11, regardless of their average primary bearing ratio at threshold 10 microns values, have average Ppm-Pvm values greater than about 0.96 micron and less than or equal to about 4.76 microns. Furthermore, all exemplary embodiments, EX1-EX11, have average primary bearing ratio at threshold 10 microns values less than about 36.09% and average Ppm-Pvm values greater than about −1.54 microns, specifically, average primary bearing ratio at threshold 10 microns values less than or equal to about 14.44% and average Ppm-Pvm values greater than or equal to about 0.96 micron. Even more specifically, average primary bearing ratio at threshold 10 microns values less than or equal to about 14.44% and greater than or equal to about 2.55%, and average Ppm-Pvm values greater than or equal to about 0.96 micron and less than or equal to about 4.76 microns.

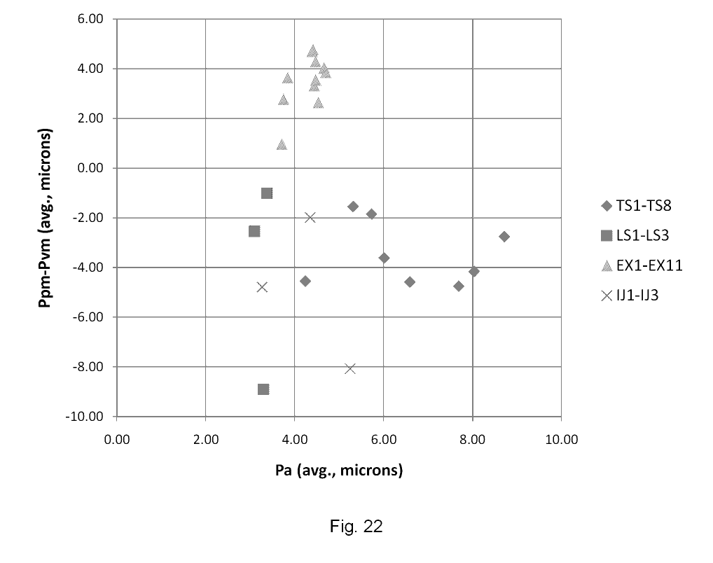

FIG. 22 plots the average of the CD and MD values of Ppm-Pvm against the average of the CD and MD values of the Pa. Specifically, it can be seen in FIG. 22 and TABLE V that all exemplary embodiments, EX1-EX11, have average Ppm-Pvm values greater than about −1.01 microns, regardless of the average Pa value. Even more specifically, all exemplary embodiments, EX1-EX11, have average Ppm-Pvm values greater than or equal to about 0.96 micron, regardless of the average Pa value. Even more specifically, all exemplary embodiments, EX1-EX11, have average Ppm-Pvm values greater than or equal to about 0.96 micron and less than or equal to about 4.76 microns, regardless of the average Pa value. Yet even more specifically, all exemplary embodiments, EX1-EX11, have average Ppm-Pvm values greater than or equal to about 0.96 micron and less than or equal to about 4.76 microns, and average Pa values greater than or equal to about 3.71 microns and less than or equal to about 4.66 microns.

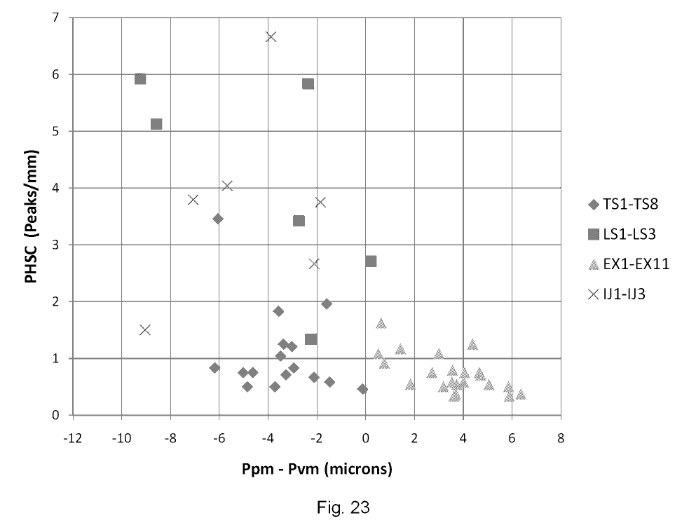

FIG. 23 plots PHSC (both CD and MD) against Ppm-Pvm (both CD and MD). Specifically, it can be seen from FIG. 23 and TABLE II that all exemplary embodiments, EX1-EX11, have PHSC values less than about 2.71 peaks/mm and Ppm-Pvm values greater than about −0.12 micron. More specifically, all exemplary embodiments, EX1-EX11, have PHSC values less than or equal to about 1.63 peaks/mm and Ppm-Pvm values greater than or equal to about 0.51 micron. Even more specifically, all exemplary embodiments, EX1-EX11, have PHSC values less than or equal to about 1.63 peaks/mm and greater than or equal to about 0.34 peaks/mm, and Ppm-Pvm values greater than or equal to about 0.51 micron and less than or equal to about 6.35 microns.

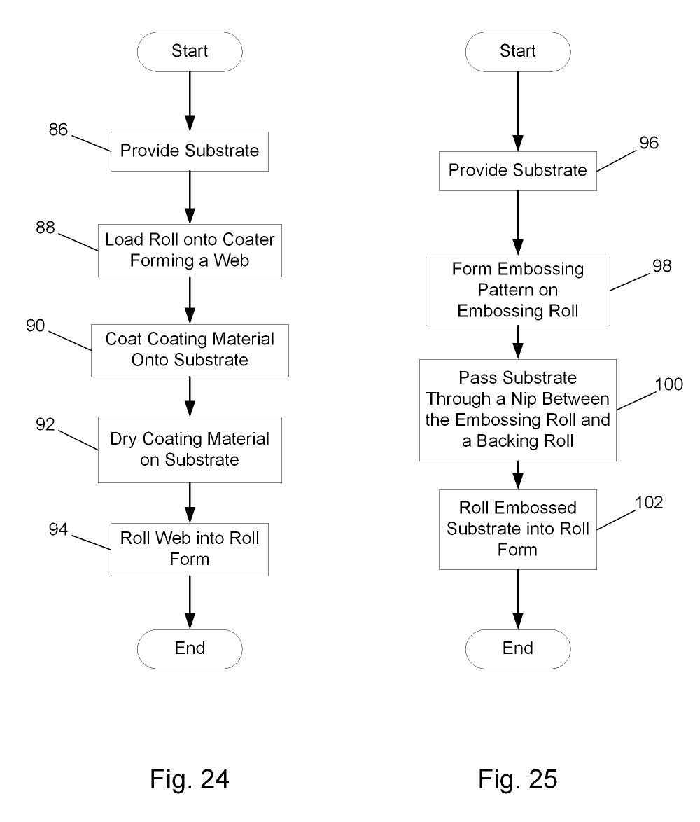

A print-receptive medium having a print-receptive surface with the above-described surface roughness properties (Pp, Pv, Pa, Ppm, Pvm, and bearing ratios at threshold 5 microns and 10 microns) can be prepared by the method outlined in FIG. 24. A roll of substrate material is provided to a roll coater at step 86. The roll is loaded onto the coater to form a web at step 88, and coater is operated under typical coating conditions. A coating material is applied by any method known to one skilled in the art, typically using, for example, slot coating, curtain coating, or gravure coating, at step 90. Alternatively, the material can be sprayed or otherwise applied to the web. The coating material is dried under conditions known to those skilled in the art at step 92. Additionally, after drying, the web can be remoisturized to provide a coated substrate with reduced tendency to curl. Other coatings, for example, adhesives, release agents, etc., can be added to the web either before or after the coating material. After drying, the coated web can be rewound into roll form at step 94. At a later time, the roll of coated substrate can be converted on a converting press to form any number of print-receptive media, for example, address labels, file folder labels, stickers, and other labels, business cards, greeting cards, name badges, tent cards, etc. Alternatively, the dried, coated web can be converted into intermediate or finished print-receptive media directly from the coater without the intermediate roll form.

An alternative method of manufacturing a print-receptive medium of the current invention includes embossing the print-receptive surface into a substrate, and is outlined in FIG. 25. Embossing is a process well-known to those skilled in the art. A substrate, for example, paper, cardstock, film, or any other material suitable for accepting an embossed pattern, is provided at step 96. An embossed pattern is formed on an embossing roll such that the embossed pattern can be transferred to the substrate to form the peaks and valleys of the print-receptive media at step 98. The pattern is transferred, typically under heat and pressure, by passing the substrate through a nip formed between a backing roll and the embossing roll at step 100. Alternatively, if the substrate is film, the molten film can be extruded into the nip. During extrusion, the embossing roll and/or the backing roll can be chilled to help solidify and allow release of the film from the rolls. If the embossed pattern is desired on both sides of the substrate, the backing roll can be a second embossing roll. After embossing, the embossed substrate can be rolled into an embossed roll at step 102, or converted as described above. Alternatively, the embossed substrate can be laminated to a second substrate to form a print-receptive laminate that can be converted as described above.

Additional alternative methods of manufacturing the print-receptive medium include printing on a substrate, such as, but not limited to, a paper substrate and a polymeric substrate (which polymeric substrate can be opaque, clear, translucent, or otherwise); and using a size material in forming a substrate, such as, but not limited to, a pulp-based substrate, for example, a paper substrate.

More specifically, for example, one could apply a particle-containing coating to the surface of a paper or polymeric substrate and, by controlling the particle size and proportion in the coating, achieve the print-receptive surface described above. Alternatively, where the print-receptive material is paper or a polymeric film, the material can be embossed or calendared, either as part of the paper-making or film-making process or afterwards, so as to have a certain degree and type of desired roughness. For example, the print-receptive surface can be formed directly on the surface of a film, for example, by extruding the film onto a suitably profiled chill roll. Similarly, protrusions can be formed in paper by using a calendar roll or a pressing template to emboss a paper substrate with protruding features. Alternatively, one can print onto the material in such a way as to build up the print-receptive surface. For example, screen printing or UV ink printing can be used to apply resins onto a paper surface, which, after solidifying, become at least a part of the print-receptive surface. Alternatively, by including specifically sized and/or shaped particles in a paper pulp used to make paper, one could create paper in which such particles protrude out of the paper to a desired extent, forming the print-receptive surface. The aforementioned particles could be spherical, plate-like, fiber-like, or any other regular or irregular shape.

As still another method for preparing the above-described print-receptive surface, one could scatter hot-melt particles on top of a paper or other substrate surface. Then, the paper with the particles could experience some heating with temperature above the melting or T_{g}, or glass transition temperature, of the particles, as well as some degree of pressure. After cooling, the particles will solidify and remain as at least a part of the print-receptive surface.

As noted above, a print-receptive medium having one or more of the above-described properties of surface roughness (Pp, Pv, Pa, Ppm, Pvm, and bearing ratios at threshold 5 microns and 10 microns) can be made by applying a print-receptive coating to one or more surfaces of a substrate. Suitable materials for use as the substrate include, but are not limited to, paper, polymeric films, and other materials suitable for electrophotographic printers. The only limits on the types of materials that can be used as the substrate are related to printer requirements. For example, certain low softening point films can melt in electrophotographic printers and, therefore, can be unsuitable for use as the substrate. The overall thickness of the substrate can be limited by the useful range of thickness of print-receptive media that can pass through the printer. Materials that are too thin will tend to be too flexible for the media path through the printer while materials that are too thick will not be able to fit through tight tolerances or will be too stiff for the media path.

The coating composition of the print-receptive coating can be formulated so that a desired combination of the surface roughness (Pp, Pv, Pa, Ppm, Pvm, and bearing ratios at threshold 5 microns and 10 microns) can be achieved. For example, where paper or a polymer film is used as the substrate, one can apply a suitable coating composition to the paper or polymer film substrate and then dry the coating. The components of such a coating composition can include one or more polymeric resin binders that can be coated and that can solidify on the substrate surface or, in the case of a paper substrate, that can penetrate inside the paper fibers and one or more particle types that can be dispersed in the resin binder.

The polymeric resin binder of the coating composition can be in the form of a water-based polymer solution, a polymeric emulsion, or a water-based polymeric dispersion. An example of a suitable water-based polymeric solution can be an aqueous solution of polyvinyl alcohol. An example of a polymeric emulsion can be an emulsion of polyvinyl acetate. A disadvantage of water-based solutions like the aforementioned polyvinyl alcohol solution is that the resulting coating typically has inferior water resistance as compared to a coating prepared from a polymeric emulsion like polyvinyl acetate. Preferably, the binder resins have a relatively high T_{g} so as to possess suitably high hardness and non-blocking properties.

The dispersed particles of the coating composition can be any of a wide variety of particle material types. For example, the particles can be organic materials including, but not limited to, epoxies, acrylics, polyamides, polypropylenes, polyethylenes, polyurethanes, and the like. Alternatively, the particles can be inorganic materials including, for example, but not limited to, silicates, silica, CaCO₃, talc, and the like. In terms of particle size used in the print-receptive coating, in general, as the particle size increases, the discoloration of the print-receptive medium following multiple feedings through the printer decreases. However, if the particle size is too large, the print-receiving surface can become so rough that toner adhesion becomes poor due to poor fusing. Consequently, the particles preferably have a particle size of about 10 microns to about 60 microns in diameter, more preferably about 10 microns to about 40 microns in diameter. Also, the particles preferably have a melting temperature higher than about 50° C., more preferably higher than about 100° C., and even more preferably higher than about 150° C. Preferred particle material types can include polyamide particles, particularly polar polyamide particles, such as polyamide-6 particles and polyamide-6/12 particles. Such polyamide particles can be preferred over less polar polyamide particles, like polyamide-12 particles, because the more polar polyamide particles can be more easily dispersed in water, because they can have higher melting temperatures to tolerate the heat of electrophotographic printers, and because the more polar particles can adhere better to toner. An example of a suitable particle type includes ORGASOL 1002 D NAT polyamide powder (Arkema, Inc., Philadelphia, Pa., USA), a spheroidal powder of polyamide-6, with an average particle diameter of about 20 μm and a melting temperature of 217° C. An example of another suitable particle type includes EPOSTAR MA 1013 cross-linked polymethacrylate powder (Nippon Shokubai Co., Ltd. Osaka, Japan), a spheroidal powder having an average particle size of about 12 microns to about 15 microns.

The coating composition can further include one or more of the following: colorants, optical brighteners, whiteners, anti-settling agents, thickeners, and the like.

The graying or discoloration of a print-receptive medium can be evaluated objectively by measuring the color difference of the print-receptive medium in one or more unprinted areas before and after passing the print-receptive medium through an electrophotographic printer. The aforementioned color difference or ΔE*_{ab} can be determined using the industry standard CIE L*a*b* measurement, wherein

ΔE*_{ab}=\sqrt{(L*₂−L*₁)²+(a*₂−a*₁)²+(b*₂−b*₁)²}

wherein L*₂ and L*₁ represent lightness of color in an unprinted area after and before, respectively, one or more feedings through the electrophotographic printer, a*₂ and a*₁ represent position between red/magenta and green in an unprinted area after and before, respectively, one or more feedings through the electrophotographic printer, and b*₂ and b*₁ represent position between yellow and blue in an unprinted area after and before, respectively, one or more passes through the electrophotographic printer.

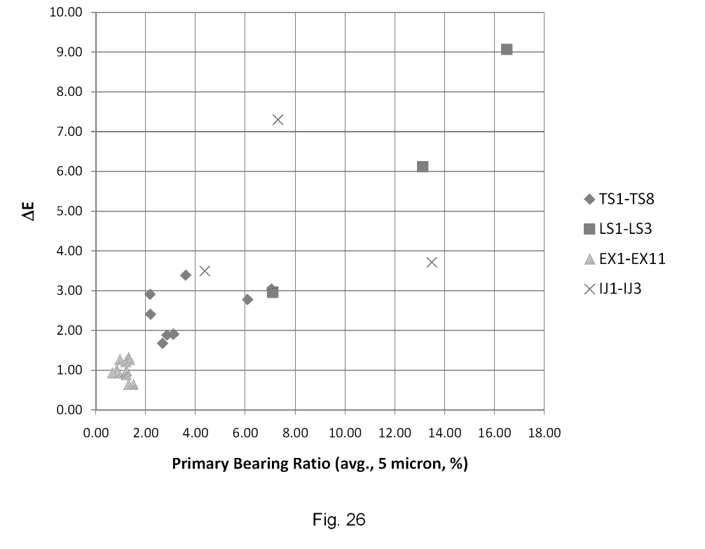

TABLE V includes ΔE*_{ab} for commercially available samples (TS1-TS8, LS1-LS3, and IJ1-IJ3) and for exemplary embodiments (EX1-EX11) after ten passes through an HP LASERJET 1320. As can be seen, exemplary embodiments (EX1-EX11) have ΔE*_{ab} values less than about 1.68. More specifically, the exemplary embodiments (EX1-EX11) have ΔE*_{ab} values less than or equal to about 1.32. FIG. 26 illustrates the relationship between ΔE*_{ab} and the average primary bearing ratio at threshold 5 microns from TABLE V. The exemplary embodiments (EX1-EX11) have ΔE*_{ab} values less than about 2.41 and average primary bearing ratio at threshold 5 microns values less than about 2.67%. Specifically, exemplary embodiments (EX1-EX11) have ΔE*_{ab} values less than or equal to about 1.32 and average primary bearing ratio at threshold 5 microns values less than or equal to about 1.51%.

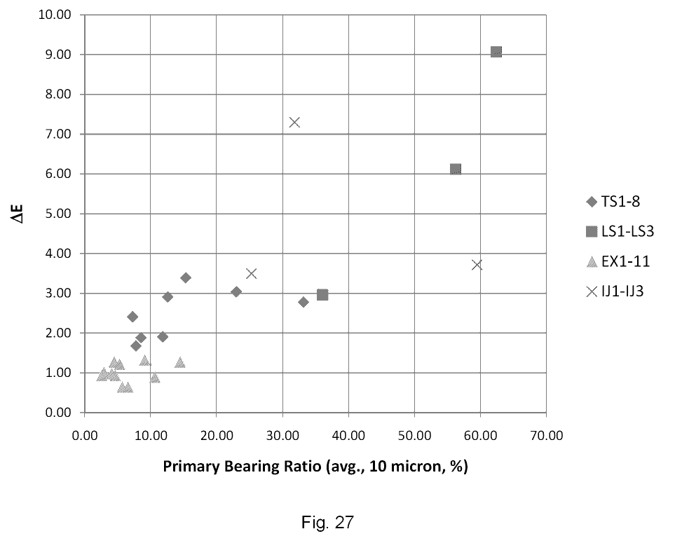

FIG. 27 illustrates the relationship between ΔE*_{ab} and the average primary bearing ratio at threshold 10 microns from TABLE V. Exemplary embodiments (EX1-EX5, EX8, EX10, and EX11) have ΔE*_{ab} values less than about 2.41 and average primary bearing ratio at threshold 10 microns values less than about 7.23%. Specifically, exemplary embodiments (EX1-EX5, EX8, EX10, and EX11) have ΔE*_{ab} values less than or equal to about 1.27 and average primary bearing ratio at 10 microns values less than or equal to about 6.54%. Even more specifically, exemplary embodiments (EX1-EX5, EX8, EX10, and EX11) have ΔE*_{ab} values less than or equal to about 1.27 and greater than or equal to about 0.64, and average primary bearing ratio at 10 microns values less than or equal to about 6.54% and greater than or equal to about 2.88%. Exemplary embodiments (EX1-EX11), regardless of the average primary bearing ratio at 10 microns value, have ΔE*_{ab} values less than about 1.68. Specifically, exemplary embodiments (EX1-EX11), regardless of the average primary bearing ratio at 10 microns value, have ΔE*_{ab} values less than about 1.32. Even more specifically, exemplary embodiments (EX1-EX11), regardless of the average primary bearing ratio at 10 microns value, have ΔE*_{ab} values less than about 1.32 and greater than or equal to about 0.64.

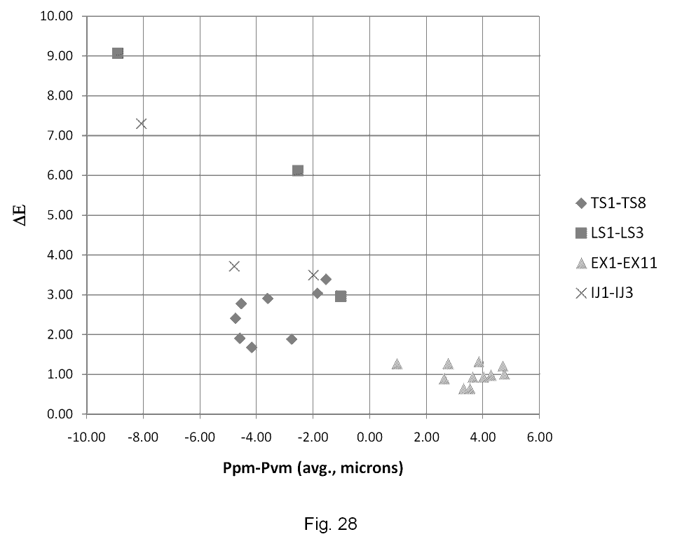

FIG. 28 illustrates the relationship between ΔE*_{ab} and average Ppm-Pvm from TABLE V. The exemplary embodiments (EX1-EX11) have ΔE*_{ab} values less than about 2.96 and average Ppm-Pvm values greater than about −2.75 microns. Specifically, exemplary embodiments (EX1-EX11) have ΔE*_{ab} less than or equal to about 1.32 and average Ppm-Pvm values greater than or equal to about 0.96 micron. Even more specifically, exemplary embodiments (EX1-EX11) have ΔE*_{ab} less than or equal to about 1.32 and greater than or equal to about 0.64, and average Ppm-Pvm values greater than or equal to about 0.96 micron and less than or equal to about 4.76 microns.

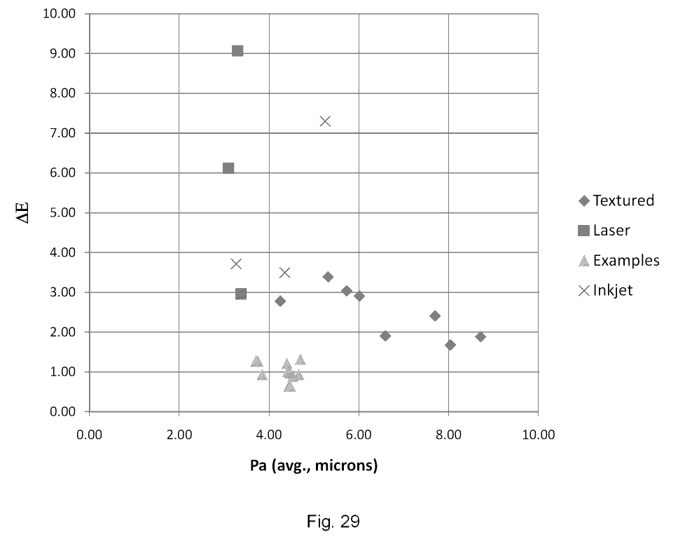

FIG. 29 illustrates the relationship between ΔE*_{ab} and average Pa from TABLE V. The exemplary embodiments (EX1-EX11) have ΔE*_{ab} values less than about 2.78 and average Pa values less than about 6.59 microns. Specifically, exemplary embodiments (EX1-EX11) have ΔE*_{ab} values less than or equal to about 1.32 and average Pa values less than or equal to about 4.70 microns. More specifically, exemplary embodiments (EX1-EX11) have ΔE*_{ab} values less than or equal to about 1.32 and greater than or equal to about 0.64, and average Pa values less than or equal to about 4.70 microns and greater than or equal to about 3.71 microns.

All features disclosed in the specification, including the claims, abstract, and drawings, and all of the steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1: A print-receptive medium comprising:
a print-receptive surface that includes a plurality of peaks and a plurality of valleys;
the print-receptive surface having a primary profile including a mean surface;
each of the plurality of peaks having a height measured from the mean surface, and each of the plurality of valleys having a depth measured from the mean surface; and
the plurality of peaks having a mean peak height Ppm and the plurality of valleys having a mean valley depth Pvm;
wherein the primary profile of the print-receptive surface has a value of Ppm-Pvm greater than about 0.23 micron.

2: The print-receptive medium of claim 1, wherein the primary profile of the print-receptive surface has a value of Ppm-Pvm greater than or equal to about 0.51 micron.

3: The print-receptive medium of claim 1, wherein the primary profile of the print-receptive surface has a value of Ppm-Pvm ranging from about 0.51 micron to about 6.35 microns.

4: The print-receptive medium of claim 1, further comprising:
the print-receptive surface having a primary bearing ratio at threshold 5 microns;
wherein the primary bearing ratio at threshold 5 microns of the print-receptive surface has a value less than about 7.11%.

5: The print-receptive medium of claim 4, wherein the primary bearing ratio at threshold 5 microns of the print-receptive surface has a value less than or equal to about 1.51%.

6: The print-receptive medium of claim 4, wherein the primary bearing ratio at threshold 5 microns of the print-receptive surface has a value less than or equal to about 1.51% and Ppm-Pvm has a value greater than or equal to about 0.96 micron.

7: The print-receptive medium of claim 4, wherein the primary bearing ratio at threshold 5 microns of the print-receptive surface has a value ranging from about 0.66% to about 1.51% and Ppm-Pvm has a value ranging from about 0.96 micron to about 4.76 microns.

8: The print-receptive medium of claim 1, wherein:
the print-receptive surface having a ΔE*_{ab} value; and
the value of ΔE*_{ab} is less than about 1.68 after ten passes through an electrophotographic printer.

9: The print-receptive medium of claim 8, wherein the value of ΔE*_{ab} is less than or equal to about 1.32 after ten passes through an electrophotographic printer.

10: The print-receptive medium of claim 8, wherein ΔE*_{ab} has a value ranging from about 0.64 to about 1.32 after ten passes through an electrophotographic printer.

11: The print-receptive medium of claim 1, further comprising:
a coating;
wherein:
the print-receptive surface is formed on the coating; and
the coating including about 100 parts by weight of polyvinyl acetate, up to about 55 parts by weight of polyamide, up to about 105 parts by weight of silica, about 8.75 parts by weight sodium chloride, and up to about 7.25 parts by weight of a thickener.

12: The print-receptive medium of claim 11, wherein the coating including about 100 parts by weight of polyvinyl acetate, up to about 55 parts by weight of polyamide, about 13.12 parts by weight to about 105 parts by weight of silica, about 8.75 parts by weight sodium chloride, and up to about 7.25 parts by weight of a thickener.

13: The print-receptive medium of claim 1, wherein:
the print-receptive surface having a primary high spot count, PHSC, value; and
the value of PHSC is less than about 2.71 peaks/mm.

14: The print-receptive medium of claim 13, wherein the value of PHSC is less than or equal to about 1.63 peaks/mm and the value of Ppm-Pvm is greater than or equal to about 0.51 micron.

15: The print-receptive medium of claim 13, wherein the value of PHSC ranges from about 0.34 peaks/mm to about 1.63 peaks/mm and the value of Ppm-Pvm ranges from about 0.051 micron to about 6.35 microns.

16: A method for forming a print-receptive medium, the method comprising:
providing a substrate having a coating surface;
providing a coating mixture;
coating the coating mixture onto the coating surface; and
drying the coating mixture;
wherein:
the dried coating mixture forms a print-receptive surface having a plurality of peaks and a plurality of valleys;
the print-receptive surface having a primary profile including a mean surface;
each of the plurality of peaks having a height measured from the mean surface, and each of the plurality of valleys having a depth measured from the mean surface;
the plurality of peaks having a mean peak height Ppm and the plurality of valleys having a mean valley depth Pvm; and
the primary profile of the print-receptive surface has a value of Ppm-Pvm greater than about 0.23 micron.

17: The method of claim 16, wherein the primary profile of the print-receptive surface has a value of Ppm-Pvm greater than or equal to about 0.51 micron.

18: The method of claim 16, wherein the primary profile of the print-receptive surface has a value of Ppm-Pvm ranging from about 0.51 micron to about 6.35 microns.

19: The method of claim 16, further comprising:
the print-receptive surface having a primary bearing ratio at threshold 5 microns;
wherein the primary bearing ratio at threshold 5 microns of the print-receptive surface has a value less than about 7.11%.

20: The method of claim 19, wherein the primary bearing ratio at threshold 5 microns of the print-receptive surface has a value less than or equal to about 1.51%.

21: The method of claim 19, wherein the primary bearing ratio at threshold 5 microns of the print-receptive surface has a value less than or equal to about 1.51% and Ppm-Pvm has a value greater than or equal to about 0.96 micron.

22: The method of claim 19, wherein the primary bearing ratio at threshold 5 microns of the print-receptive surface has a value ranging from about 0.66% to about 1.51% and Ppm-Pvm has a value ranging from about 0.96 micron to about 4.76 microns.

23: The method of claim 16, wherein:
the print-receptive surface having a ΔE*_{ab} value; and
the value of ΔE*_{ab} is less than about 1.68 after ten passes through an electrophotographic printer.

24: The method of claim 23, wherein the value of ΔE*_{ab} is less than or equal to about 1.32 after ten passes through an electrophotographic printer.

25: The method of claim 23, wherein ΔE*_{ab} has a value ranging from about 0.64 to about 1.32 after ten passes through an electrophotographic printer.

26: The method of claim 16, wherein:
the print-receptive surface having a PHSC value; and
the value of PHSC is less than about 2.71 peaks/mm.

27: The method of claim 26, wherein the value of PHSC is less than or equal to about 1.63 peaks/mm and the value of Ppm-Pvm is greater than or equal to about 0.51 micron.

28: The method of claim 26, wherein the value of PHSC ranges from about 0.34 peaks/mm to about 1.63 peaks/mm and the value of Ppm-Pvm ranges from about 0.051 micron to about 6.35 microns.

29: The method of claim 26, wherein the coating comprises about 100 parts by weight of polyvinyl acetate, up to about 55 parts by weight of polyamide, up to about 105 parts by weight of silica, about 8.75 parts by weight sodium chloride, and up to about 7.25 parts by weight of a thickener.

30: The method of claim 26, wherein the coating comprises about 100 parts by weight of polyvinyl acetate, up to about 55 parts by weight of polyamide, about 13.12 parts by weight to about 105 parts by weight of silica, about 8.75 parts by weight sodium chloride, and up to about 7.25 parts by weight of a thickener.
